(19) United States
(12) Patent Application Publication
(10) Pub. No.: US 2026/0103002 A1
(43) Pub. Date: Apr. 16, 2026

(54) PRINTER AND INK MIST COLLECTION METHOD

(71) Applicant: SCREEN Holdings Co., Ltd., Kyoto (JP)

(72) Inventors: Ikuhiko TAKAHAMA, Kyoto (JP); Norimasa MATSUI, Kyoto (JP); Hitoshi MATSUYA, Kyoto (JP)

(21) Appl. No.: 19/245,972

(22) Filed: Jun. 23, 2025

(30) Foreign Application Priority Data
Jul. 29, 2024 (JP) 2024-122100

(51) Int. Cl. B41J 2/17

(52) U.S. Cl. CPC B41J 2/1714

(57) ABSTRACT

The first space and the second space are provided on both the sides of the collection nozzle. The first airflow going from the one side toward the other side opposite to the one side in the first space is generated by giving the pressure for generating the first airflow to the first space from only the other side among the one side and the other side. Further, the second airflow going from the one side toward the other side in the second space is generated by giving the pressure for generating the second airflow to the second space from only the other side among the one side and the other side. At that time, the pressure for generating the first airflow and the pressure for generating the second airflow are generated by the collection nozzle sucking from the air intake opening. Then, the first airflow having flowed out from the first space toward the other side flows into the collection nozzle from the air intake opening, and the second airflow having flowed out from the second space toward the other side flows into the collection nozzle from the air intake opening.

### CROSS REFERENCE TO RELATED APPLICATION

The disclosure of Japanese Patent Application No. 2024-122100 filed on July 29, 2024 including specification, drawings and claims is incorporated herein by reference in its entirety.

### BACKGROUND

### 1. Field of the disclosure

This disclosure relates to a technique for collecting an ink mist generated when ink is ejected onto a printing medium to print an image.

### 2. Description of the Related Art

In a printer for printing an image on a printing medium by ejecting ink from an ejection head, an ink mist is generated. Such an ink mist becomes a factor to contaminate the printing medium and the printer. Then, in JP2015-083372, provided is a mechanism for collecting the ink mist. This mist collection mechanism has a suction port for sucking air containing the mist. Further, on both sides of the suction port, a first air outlet and a second air outlet are provided and each of the first air outlet and the second air outlet blows out air. This ensures efficient collection of the mist from the suction port.

### SUMMARY

According to JP2015-083372, pressure for generating an airflow to blow out air from the first air outlet is given from both sides. Specifically, at the first air outlet, an airflow going from an upper side toward a lower side is generated and air is blown out from the first air outlet. At that time, pressure (positive pressure) generated by an air blowing mechanism such as a fan, a pump, or the like is given to the first air outlet from the upper side. Further, pressure (negative pressure) generated by sucking air from the suction port is given to the first air outlet from the lower side. In such a configuration, depending on a balance between the pressure given from the upper side by the air blowing mechanism and the pressure given from the lower side by sucking from the suction port, the airflow to be sucked from the suction port becomes disturbed complicatedly. As a result, there is sometimes a case where a mist is adhered onto an inner wall of a collection nozzle, to thereby contaminate the collection nozzle. For this reason, there arises a problem that it takes a maintenance cost required to clean the collection nozzle and/or ink deposited on the collection nozzle drops on the printing medium. Such a phenomenon commonly happens at the second air outlet.

This disclosure is intended to solve the above-described problem, and it is an object of this disclosure to make it possible to suppress adhesion of ink onto a collection nozzle which sucks an ink mist to collect the ink mist.

A printer according to the disclosure, comprises: a printing medium transfer part transferring a printing medium in a transfer direction; an ejection head facing the printing medium and ejecting ink onto the printing medium; and a collection nozzle disposed on a downstream side in the transfer direction relative to the ejection head, having an air intake opening, which faces the printing medium from one side in a direction orthogonal to the printing medium, and sucking from the air intake opening, an ink mist generated by ejection of ink from the ejection head, wherein a first space is provided between the collection nozzle and the ejection head in the transfer direction and a second space is provided on a downstream side of the collection nozzle in the transfer direction, a first airflow going from the one side toward the other side opposite to the one side in the first space is generated by giving pressure for generating the first airflow to the first space from only the other side among the one side and the other side, a second airflow going from the one side toward the other side in the second space is generated by giving pressure for generating the second airflow to the second space from only the other side among the one side and the other side, the pressure for generating the first airflow and the pressure for generating the second airflow are generated by the collection nozzle sucking from the air intake opening, the first airflow having flowed out from the first space toward the other side flows into the collection nozzle from the air intake opening, and the second airflow having flowed out from the second space toward the other side flows into the collection nozzle from the air intake opening.

An ink mist collection method according to the disclosure, comprises: transferring a printing medium in a transfer direction; ejecting ink onto the printing medium from an ejection head facing the printing medium; and sucking an ink mist, which is generated by ejection of ink from the ejection head, from an air intake opening by a collection nozzle which is disposed on a downstream side in the transfer direction relative to the ejection head, has the air intake opening facing the printing medium from one side in a direction orthogonal to the printing medium, wherein a first space is provided between the collection nozzle and the ejection head in the transfer direction and a second space is provided on a downstream side of the collection nozzle in the transfer direction, a first airflow going from the one side toward the other side opposite to the one side in the first space is generated by giving pressure for generating the first airflow to the first space from only the other side among the one side and the other side, a second airflow going from the one side toward the other side in the second space is generated by giving pressure for generating the second airflow to the second space from only the other side among the one side and the other side, the pressure for generating the first airflow and the pressure for generating the second airflow are generated by the collection nozzle sucking from the air intake opening, the first airflow having flowed out from the first space toward the other side flows into the collection nozzle from the air intake opening, and the second airflow having flowed out from the second space toward the other side flows into the collection nozzle from the air intake opening.

In the present disclosure (the printer and the ink mist collection method) having such a configuration, the first space and the second space are provided on both the sides of the collection nozzle. The first airflow going from the one side toward the other side opposite to the one side in the first space is generated by giving the pressure for generating the first airflow to the first space from only the other side among the one side and the other side. Further, the second airflow going from the one side toward the other side in the second space is generated by giving the pressure for generating the second airflow to the second space from only the other side among the one side and the other side. At that time, the pressure for generating the first airflow and the pressure for generating the second airflow are generated by the collection nozzle sucking from the air intake opening. Then, the first airflow having flowed out from the first space toward the other side flows into the collection nozzle from the air intake opening, and the second airflow having flowed out from the second space toward the other side flows into the collection nozzle from the air intake opening.

Thus, the first airflow is generated in the first space by giving the pressure caused by an airflow generated by the collection nozzle sucking from the air intake opening, to the first space only from the other side, without giving any pressure to the first space from the one side. The relatively moderate first airflow is thereby generated. When such a first airflow flows into the collection nozzle from the air intake opening, the first airflow generates a layer of the first airflow, in other words, a layer of clean airflow along the inner wall of the collection nozzle on the side of the first space. Similarly, the second airflow is generated in the second space by giving the pressure caused by an airflow generated by the collection nozzle sucking from the air intake opening, to the second space only from the other side, without giving any pressure to the second space from the one side. The relatively moderate second airflow is thereby generated. When such a second airflow flows into the collection nozzle from the air intake opening, the second airflow generates a layer of the second airflow, in other words, a layer of clean airflow along the inner wall of the collection nozzle on the side of the second space. Then, air containing the ink mist sucked from the air intake opening goes through between the layers on both the sides. As a result, adhesion of the ink mist onto the inner wall of the collection nozzle is suppressed. Thus, it becomes possible to suppress adhesion of the ink onto the collection nozzle which sucks the ink mist to collect the ink mist.

Thus, according to the present disclosure, it becomes possible to suppress adhesion of the ink mist onto the inner wall of the collection nozzle.

### BRIEF DESCRIPTION OF THE DRAWINGS

FIG. 1 is an elevational view schematically showing a printer in accordance with the present disclosure;

FIG. 2 is a view schematically showing one example of a mist collection unit included in the printer shown in FIG. 1;

FIG. 3A is a perspective view schematically showing an appearance structure of a collection nozzle;

FIG. 3B is an elevational view schematically showing the appearance structure of the collection nozzle;

FIG. 4 is a perspective view schematically showing an internal structure of the collection nozzle;

FIG. 5A is a cross-sectional view schematically showing the internal structure of the collection nozzle;

FIG. 5B is a cross-sectional view schematically showing the internal structure of the collection nozzle;

FIG. 6 is a view schematically showing an operation of the collection nozzle;

FIG. 7 is a perspective view schematically showing an exhaust connector of an exhaust duct;

FIG. 8 is a side elevational view schematically showing a mist removing part and a suction part;

FIG. 9 is a partial sectional view schematically and emphatically showing an operation performed by lifting or lowering an ejection head and the collection nozzle;

FIG. 10 is a perspective view schematically showing an appearance structure of a cushioning material;

FIG. 11 is a partial sectional view schematically and emphatically showing an operation performed by lifting or lowering the ejection head and the collection nozzle in a configuration including the cushioning material;

FIG. 12 is a partial sectional view schematically showing a positional relation between a base frame supporting the ejection head and the collection nozzle;

FIG. 13A is a view schematically showing an attachment mechanism of the collection nozzle to the base frame supporting the ejection head;

FIG. 13B is a view schematically showing the attachment mechanism of the collection nozzle to the base frame supporting the ejection head;

FIG. 13C is a view schematically showing the attachment mechanism of the collection nozzle to the base frame supporting the ejection head;

FIG. 14 is a partial sectional view schematically showing respective functions of spaces provided on both sides of the collection nozzle;

FIG. 15A is a perspective view schematically showing a variation of the collection nozzle;

FIG. 15B is a view schematically showing a variation of a mechanism for supporting the collection nozzle shown in FIG. 15A with respect to the ejection head;

FIG. 15C is a partial sectional view schematically showing the variation of the mechanism for supporting the collection nozzle shown in FIG. 15A with respect to the ejection head;

FIG. 16A is a view showing a simulation result of a diffusion manner of an ink mist sucked into the collection nozzle;

FIG. 16B is a view showing the simulation result of the diffusion manner of the ink mist sucked into the collection nozzle;

FIG. 16C is a view showing the simulation result of the diffusion manner of the ink mist sucked into the collection nozzle;

FIG. 16D is a view showing the simulation result of the diffusion manner of the ink mist sucked into the collection nozzle;

FIG. 16E is a view showing whether a width of an air intake opening is suitable or not in a table form;

FIG. 17A is a view schematically showing an experiment for checking an effect of a tilt of a suction nozzle;

FIG. 17B is a view showing a result of the experiment shown in FIG. 17A in a table form;

FIG. 18A is a view showing a simulation result of a diffusion manner of an ink mist sucked into the collection nozzle;

FIG. 18B is a view showing whether a width of the air intake opening is suitable or not in a table form;

FIG. 19 is a partial sectional view schematically showing a variation of a positional relation of the collection nozzle with respect to the ejection head;

FIG. 20A is a partial sectional view schematically showing a variation of the printer; and

FIG. 20B is a view schematically showing a cleaned air supply unit included in the printer shown in FIG. 20A.

### DETAILED DESCRIPTION OF THE PREFERRED EMBODIMENTS

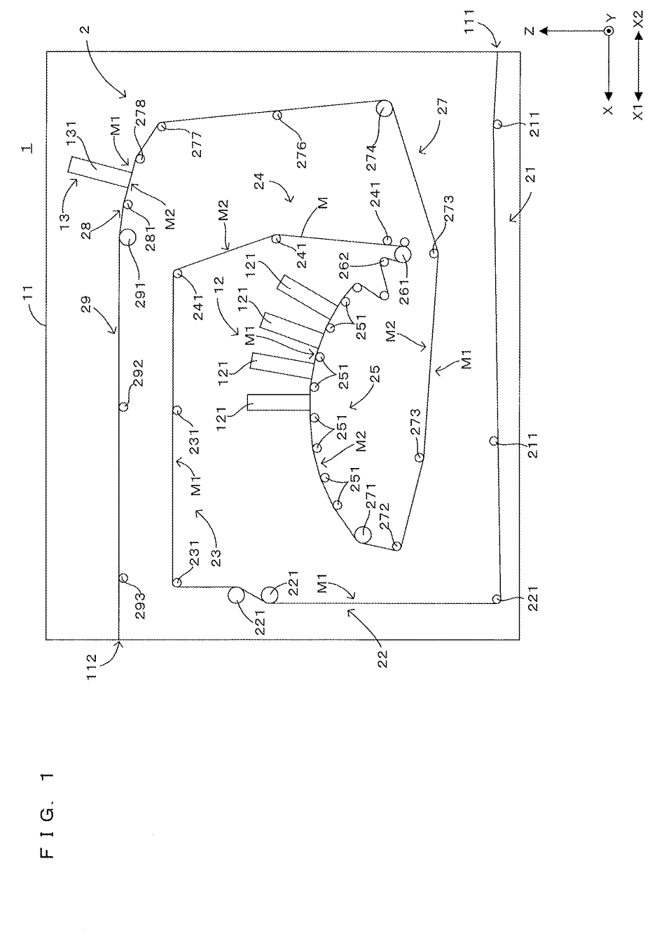

FIG. 1 is an elevational view schematically showing a printer in accordance with the present disclosure. In FIG. 1 and the following figures, an X direction which is a horizontal direction, a Y direction which is a horizontal direction orthogonal to the X direction, and a Z direction which is a vertical direction are shown as appropriate. Further, one side X1 and the other side X2 in the X direction are shown as appropriate. Herein, the one side X1 and the other side X2 face opposite to each other.

The printer 1 includes a cabinet 11, a color printing part 12 disposed inside the cabinet 11, a white printing part 13 disposed above the color printing part 12 inside the cabinet 11, and a transfer part 2 for transferring a printing medium M by using a plurality of rollers disposed inside the cabinet 11. In other words, the cabinet 11 accommodates therein the color printing part 12, the white printing part 13, and the transfer part 2.

The color printing part 12 has a plurality of (four) ejection heads 121 arranged in a traveling direction of the printing medium M (in a direction going from the other side X2 toward the one side X1) above the printing medium M transferred by the transfer part 2. The plurality of ejection heads 121 each have a nozzle facing a front surface M1 of the printing medium M passing therebelow from above, and eject color inks having different colors from the nozzles by an inkjet method. Herein, the color ink refers to ink having a color other than white, and includes inks having colors such as cyan, magenta, yellow, black, and the like. Thus, the plurality of ejection heads 121 in the color printing part 12 eject color inks, from above, onto the front surface M1 of the printing medium M passing therebelow, to thereby print a color image on the front surface M1 of the printing medium M.

Further, the white printing part 13 has a single ejection head 131 disposed above the printing medium M transferred by the transfer part 2. The ejection head 131 has a nozzle facing the front surface M1 of the printing medium M passing therebelow from above, and ejects white ink from the nozzle by an inkjet method. Thus, the ejection head 131 in the white printing part 13 ejects white ink, from above, onto the front surface M1 of the printing medium M passing therebelow, to thereby print a white image on the front surface M1 of the printing medium M.

A loading port 111 is opened in a side wall of the cabinet 11 on the other side X2, and the printing medium M is loaded into the cabinet 11 from the loading port 111. On the other hand, the transfer part 2 has a loading part 21. The loading part 21 has a plurality of rollers 211 arranged in the X direction below the color printing part 12, and the printing medium M loaded from loading port 111 is transferred from the other side X2 toward the one side X1 while being supported by the plurality of rollers 211.

Further, the transfer part 2 has an upward transfer part 22 provided on the one side X1 of the loading part 21. The upward transfer part 22 has a plurality of rollers 221 arranged in the Z direction on the one side X1 of the color printing part 12. This upward transfer part 22 folds the printing medium M having transferred by the loading part 21 upward by the roller 221 positioned at a lower end among the plurality of rollers 221, to thereby change the traveling direction of the printing medium M upward from the one side X1, and then transfers the printing medium M upward while supporting the printing medium M by the plurality of rollers 221. Thus, the printing medium M is transferred by the upward transfer part 22 from the lower side toward the upper side of the color printing part 12.

Furthermore, the transfer part 2 has an upper transfer part 23 provided above the color printing part 12. The upper transfer part 23 has a plurality of rollers 231 arranged in the X direction above the color printing part 12. This upper transfer part 23 folds the printing medium M having transferred from the upward transfer part 22 toward the other side X2 by the roller 231 positioned at an end of the one side X1 among the plurality of rollers 231, to thereby change the traveling direction of the printing medium M from the upper side toward the other side X2, and then transfers the printing medium M toward the other side X2 while supporting the printing medium M by the plurality of rollers 231.

Further, the transfer part 2 has a downward transfer part 24 provided on the other side X2 of the upper transfer part 23. The downward transfer part 24 has a plurality of rollers 241 arranged in the Z direction on the other side X2 of the color printing part 12. This downward transfer part 24 folds the printing medium M having transferred from the upper transfer part 23 downward by the roller 241 positioned at an upper end among the plurality of rollers 241, to thereby change the traveling direction of the printing medium M downward from the other side X2, and then transfers the printing medium M downward while supporting the printing medium M by the plurality of rollers 241. The roller 241 at the upper end among the plurality of rollers 241 included in this downward transfer part 24 is positioned above each of the ejection heads 121 in the color printing part 12, and the roller 241 at the lower end is positioned below each of the ejection heads 121 in the color printing part 12. In other words, the downward transfer part 24 transfers the printing medium M from the upper side toward the lower side of the color printing part 12.

Furthermore, the transfer part 2 has a color transfer part 25 provided on the one side X1 of the downward transfer part 24 below the upper transfer part 23. The color transfer part 25 has a plurality of rollers 251 arranged in the X direction, being in contact with a back surface M2 of the printing medium M, and the printing medium M having transferred from the downward transfer part 24 is supported below the color printing part 12 by the plurality of rollers 251. Thus, the plurality of rollers 251 of the color transfer part 25 are in contact with the back surface M2 of the printing medium M having transferred from the downward transfer part 24 from below, to thereby transfer the printing medium M from the other side X2 toward the one side X1 while supporting the printing medium M from below. Then, the ejection heads 121 in the color printing part 12 eject color inks from above onto the front surface M1 of the printing medium M transferred along the front surface M1 by the color transfer part 25.

At that time, the front surface M1 of the printing medium M transferred by the color transfer part 25 faces upward and the back surface M2 of the printing medium M faces downward. In more detail, the printing medium M is loaded from the loading port 111 with the front surface M1 thereof facing upward and transferred by the loading part 21 from the other side X2 toward the one side X1. The printing medium M passing through the loading part 21 is inverted front to back by the upward transfer part 22 and the upper transfer part 23 and transferred by the upper transfer part 23 from the one side X1 toward the other side X2. For this reason, the front surface M1 of the printing medium M transferred by the upper transfer part 23 faces downward. The printing medium M passing through the upper transfer part 23 is inverted front to back by the downward transfer part 24 and the color transfer part 25 and transferred by the color transfer part 25 from the other side X2 toward the one side X1. For this reason, the front surface M1 of the printing medium M transferred by the color transfer part 25 faces upward.

Further, the transfer part 2 has rollers 261 and 262, being in contact with the printing medium M on the upstream side of the color transfer part 25 in the traveling direction of the printing medium M. The roller 261 is a driving roller for driving the printing medium M.

Furthermore, the transfer part 2 has an inversion transfer part 27 for inverting the printing medium M front to back twice, which is transferred from the color transfer part 25 to the one side X1. This inversion transfer part 27 has a plurality of rollers 271 and 272 arranged in the Z direction on the one side X1 of the color transfer part 25, being in contact with the back surface M2 of the printing medium M. Among the plurality of rollers 271 and 272, the roller 271 at the upper end is a driving roller for driving the printing medium M. This roller 271 folds the printing medium M having transferred from the color transfer part 25 downward, to thereby change the traveling direction of the printing medium M downward from the one side X1. Further, the roller 272 at the lower end folds the printing medium M having transferred from the roller 271 toward the other side X2, to thereby change the traveling direction of the printing medium M from the lower side toward other side X2. Thus, the printing medium M is inverted front to back by the rollers 271 and 272, being in contact with the back surface M2 of the printing medium M, and the back surface M2 of the printing medium M thereby faces upward and the front surface M1 of the printing medium M faces downward.

Further, the inversion transfer part 27 has a plurality of rollers 273 arranged in the X direction on the other side X2 of the roller 272 below the color transfer part 25, being in contact with the back surface M2 of the printing medium M. These rollers 273 transfer the printing medium M having transferred from the roller 272, from the one side X1 toward the other side X2. Thus, the printing medium M with the back surface M2 facing upward is transferred from the one side X1 toward the other side X2 by the plurality of rollers 273, being in contact with the back surface M2 of the printing medium M.

Furthermore, the inversion transfer part 27 has a plurality of rollers 274, 276, and 277 arranged in the Z direction on the other side X2 of the plurality of rollers 273 and the downward transfer part 24, being in contact with the back surface M2 of the printing medium M. Among the plurality of rollers 274 to 277, the roller 274 at the lower end folds the printing medium M having transferred from the plurality of rollers 273 upward, to thereby change the traveling direction of the printing medium M upward from the other side X2, and the roller 277 at the upper end folds the printing medium M having transferred from the roller 274 via the roller 276 toward the one side X1, to thereby change the traveling direction of the printing medium M from the upper side toward one side X1. Thus, the printing medium M is inverted front to back by the rollers 274 to 277, being in contact with the back surface M2 of the printing medium M, and the front surface M1 of the printing medium M thereby faces upward and the back surface M2 of the printing medium M faces downward.

Further, the inversion transfer part 27 has a roller 278 disposed on the one side X1 of the roller 277 above the upper transfer part 23, being in contact with the back surface M2 of the printing medium M. The roller 278 transfers the printing medium M having transferred from the roller 277 from the other side X2 toward the one side X1. Thus, the printing medium M with the front surface M1 thereof facing upward is transferred from the other side X2 toward the one side X1 by the roller 278 being in contact with the back surface M2 of the printing medium M.

Thus, the inversion transfer part 27 transfers the printing medium M having transferred from the color transfer part 25 downward by the rollers 271 and 272 and further transfers the printing medium M with the traveling direction thereof changed toward the other side X2 by the roller 272, to thereby invert the front surface M1 and the back surface M2 of the printing medium M front to back. Subsequently, the inversion transfer part 27 transfers the printing medium M from the one side X1 toward the other side X2 by the plurality of rollers 273 and then transfers the printing medium M upward by the rollers 274 to 277. Further, the inversion transfer part 27 changes the traveling direction of the printing medium M by the roller 277 toward the one side X1, to thereby invert the front surface M1 and the back surface M2 of the printing medium M front to back again and transfer the printing medium M from the other side X2 toward the one side X1 by the roller 278.

Thus, the inversion transfer part 27 inverts the front surface M1 and the back surface M2 of the printing medium M front to back twice by using only the rollers 271 to 278 rotating while being in contact with the back surface M2 of the printing medium M and wound with the back surface M2 of the printing medium M. In other words, the inversion transfer part 27 can invert the front surface M1 and the back surface M2 of the printing medium M front to back twice without providing any support member such a roller or an air turn bar on the side of the front surface M1 of the printing medium M.

Further, the transfer part 2 has a white transfer part 28 provided on the one side X1 relative to the roller 278 of the inversion transfer part 27 above the upper transfer part 23. This white transfer part 28 has a roller 281, and the printing medium M having transferred from the roller 278 of the inversion transfer part 27 is supported below the white printing part 13 by the roller 281. Thus, the roller 281 of the white transfer part 28 is in contact with the back surface M2 of the printing medium M having transferred from the roller 278 of the inversion transfer part 27 from below, to thereby transfer the printing medium M from the other side X2 toward the one side X1 while supporting the printing medium M from below. Then, the ejection head 131 of the white printing part 13 ejects white ink, from above, onto the front surface M1 of the printing medium M having transferred along the front surface M1 thereof by the white transfer part 28.

Furthermore, the transfer part 2 has an unloading part 29 provided on the one side X1 of the white transfer part 28 above the upper transfer part 23. This unloading part 29 has a plurality of rollers 291, 292, and 293 arranged in the X direction, being in contact with the back surface M2 of the printing medium M. The roller 291 is a driving roller for driving the printing medium M, and the rollers 292 and 293 rotate, accompanying the transfer of the printing medium M. On the other hand, an unloading port 112 is opened in a side wall of the cabinet 11 on the one side X1, and the plurality of rollers 291 to 293 of the unloading part 29 transfer the printing medium M from the other side X2 toward the one side X1 while being in contact with the back surface M2 of the printing medium M from below, to thereby unload the printing medium M from the unloading port 112.

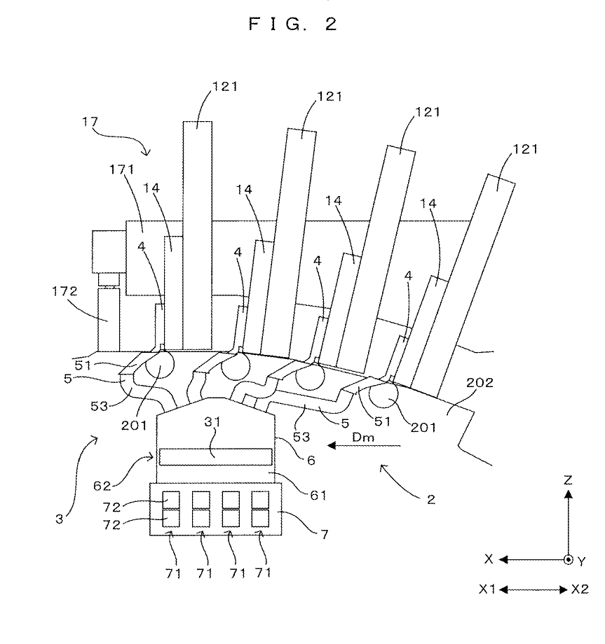

In the above-described printer 1, the transfer part 2 transfers the printing medium M in a path shown in FIG. 1 by the plurality of rollers. On the printing medium M transferred by the transfer part 2, the color printing part 12 ejects color ink to print a color image (color image printing), and the white printing part 13 ejects white ink to print a white image (white image printing). In such a printer 1, part of the color ink ejected from each of the ejection heads 121 of the color printing part 12 spatters as an ink mist. Further, part of the white ink ejected from the ejection head 131 of the white printing part 13 spatters as an ink mist. Then, the printer 1 includes a mist collection unit 3 (see FIG. 2) for collecting the ink mist. Furthermore, hereinafter, description will be made, centering on the mist collection unit 3 for the color printing part 12, but a mist collection unit 3 may be provided also for the white printing part 13, like that for the color printing part 12.

FIG. 2 is a view schematically showing one example of the mist collection unit included in the printer shown in FIG. 1. Further, in FIG. 2, each of the rollers included in the transfer part 2 is generally referred to as a "roller 201". Furthermore, in FIG. 2, one support plate 202 among a pair of support plates 202 included in the transfer part 2 is shown. In other words, the transfer part 2 has a pair of support plates 202 disposed with a space left therebetween in the Y direction. The rollers 201 are arranged in parallel with the Y direction between the pair of support plates 202 and rotatably supported by the pair of support plates 202. By this transfer part 2, the printing medium M is transferred in a transfer direction Dm.

The mist collection unit 3 has a collection nozzle 4 disposed above the printing medium M supported by the transfer part 2. In the mist collection unit 3, particularly, a plurality of collection nozzles 4 are provided corresponding to the plurality of ejection heads 121, respectively, and each of the plurality of collection nozzles 4 is disposed on a downstream side of the corresponding ejection head 121 in the transfer direction Dm. A base frame 14 is disposed between the collection nozzle 4 and the ejection head 121 corresponding to the collection nozzle 4, and the collection nozzle 4 is fixed to the corresponding ejection head 121 by the base frame 14.

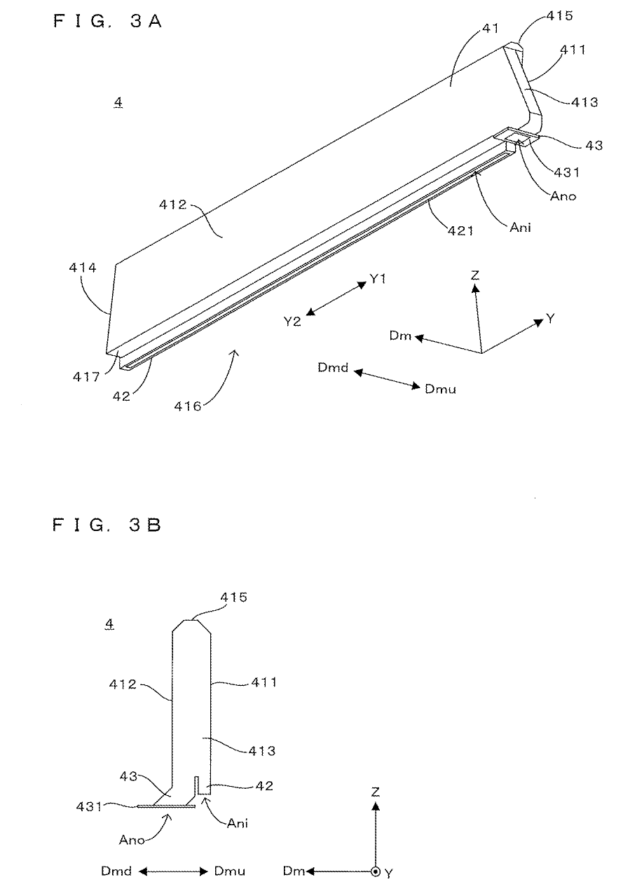

FIG. 3A is a perspective view schematically showing an appearance structure of the collection nozzle, and FIG. 3B is an elevational view schematically showing the appearance structure of the collection nozzle. In FIG. 3A, one side Y1 and the other side Y2 in the Y direction, and a downstream side Dmd and an upstream side Dmu in the transfer direction Dm are shown. Herein, the one side Y1 and the other side Y2 face opposite to each other, and the downstream side Dmd and the upstream side Dmu face opposite to each other. Further, as shown in FIG. 2, the mist collection unit 3 has the plurality of collection nozzles 4 having different tilts, and these collection nozzles 4 have a common configuration except a difference of the tilt. Then, in FIGS. 3A and 3B, description will be made, taking the mist collection unit 3 disposed in parallel with the Z direction as an example. In such description, the Z direction corresponds to a "direction orthogonal to the printing medium" of the present disclosure, the upper side in the Z direction corresponds to "one side" of the present disclosure, and the lower side in the Z direction corresponds to "the other side" of the present disclosure.

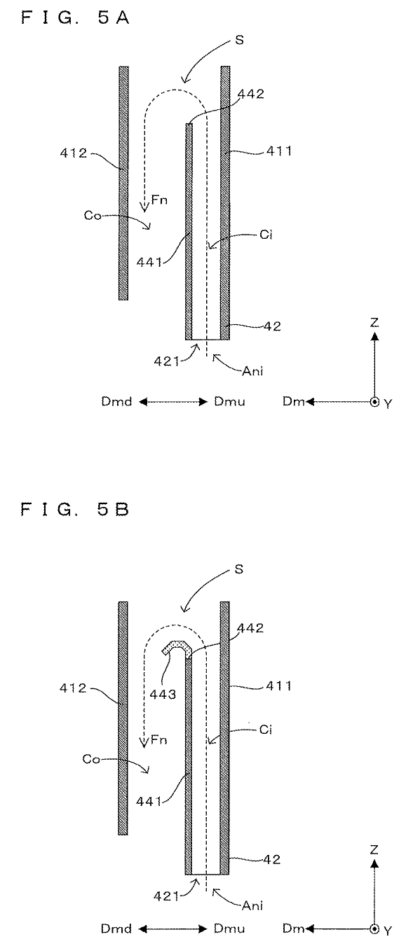

The collection nozzle 4 has a nozzle housing 41 having a long length in the Y direction, and inside the nozzle housing 41, provided is a flow path space S (see FIGS. 5A and 5B) which is a path of air. The nozzle housing 41 has a side cover 411 and a side cover 412 which are provided with a space left therebetween in the transfer direction Dm. The side cover 411 stands in parallel with the Z direction on the upstream side Dmu relative to the side cover 412 (in other words, on the side of the corresponding ejection head 121). The side cover 412 stands in parallel with the Z direction on the downstream side Dmd relative to the side cover 411 (in other words, on the opposite side of the corresponding ejection head 121).

Further, the nozzle housing 41 has a side cover 413 and a side cover 414 which are provided with a space left therebetween in the Y direction. The side cover 413 is extended in the Z direction, being inclined in the Z direction on the one side Y1 relative to the side cover 414. The side cover 414 stands in parallel with the Z direction on the other side Y2 relative to the side cover 413. The side covers 411, 412, 413, and 414 surround the flow path space S inside the nozzle housing 41 from the side (from the horizontal direction). Further, the side cover 411 has a top cover 415 which is so provided as to connect respective upper ends of the side covers 411, 412, 413, and 414. This top cover 415 covers the flow path space S surrounded by the side covers 411, 412, 413, and 414 from above.

On a bottom 416 of the nozzle housing 41, provided is a bottom cover 417 extended in the Y direction. The bottom cover 417 is so provided horizontally as to connect the side covers 412 and 414. In other words, the side cover 412 stands upward from an end of the bottom cover 417 on the downstream side Dmd, and the side cover 414 stands upward from an end of the bottom cover 417 on the other side Y2. This bottom cover 417 is extended from a lower end of the side cover 412 toward the upstream side Dmu and faces an end portion of the flow path space S inside the nozzle housing 41 on the upstream side Dmu, from below.

Further, the nozzle housing 41 has a nozzle intake part 42 protruding downward from the bottom cover 417 on the bottom 416 of the nozzle housing 41. The nozzle intake part 42 is so extended in the Y direction as to be adjoined to the bottom cover 417 from the upstream side Dmu. In a bottom 421 (lower end) of the nozzle intake part 42, an air intake opening Ani extended in the Y direction is opened downward. The air intake opening Ani of the nozzle intake part 42 faces the flow path space S from below on the upstream side Dmu relative to the bottom cover 417 and communicates with the flow path space S. This air intake opening Ani faces, from above, the front surface M1 of the printing medium M supported by the roller 201 of the transfer part 2.

Furthermore, the nozzle housing 41 has a nozzle exhaust part 43 protruding downward from the bottom 416. The nozzle exhaust part 43 is provided on the downstream side Dmd relative to the nozzle intake part 42 and on the one side Y1 relative to the bottom cover 417. This nozzle exhaust part 43 is outside the printing medium M supported by the roller 201 of the transfer part 2, to the one side Y1 in the Y direction, and does not face the printing medium M. In the lower end of this nozzle exhaust part 43, an air exhaust opening Ano is opened downward. This air exhaust opening Ano communicates with the flow path space S inside the nozzle housing 41. Further, in the lower end of the nozzle exhaust part 43, a flange 431 is so provided as to surround the air exhaust opening Ano.

As described above, the collection nozzle 4 has the air intake opening Ani facing the printing medium M from above and the air exhaust opening Ano provided outside the printing medium M in the Y direction. Then, the air intake opening Ani and the air exhaust opening Ano are communicate with each other through the flow path space S inside the nozzle housing 41. Therefore, when the air exhaust opening Ano is sucked as described later, formed is an airflow Fn (see FIGS. 5A and 5B) reaching the air exhaust opening Ano from the air intake opening Ani through the flow path space S.

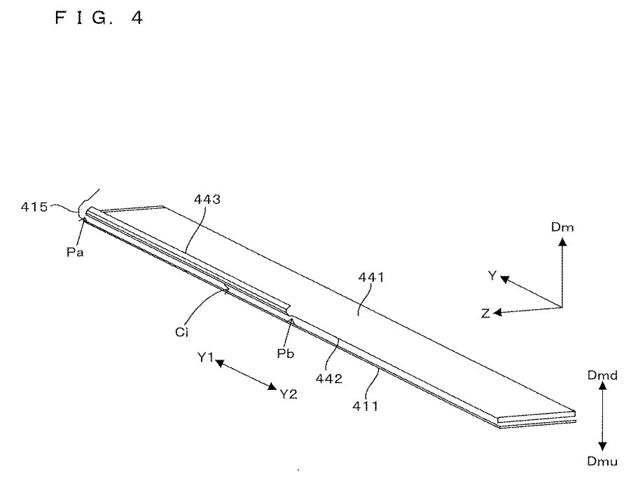

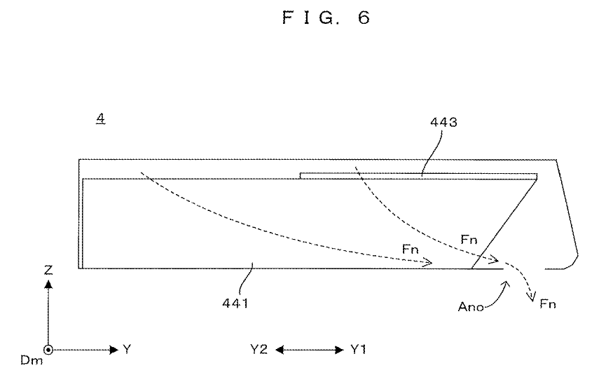

FIG. 4 is a perspective view schematically showing an internal structure of the collection nozzle, FIGS. 5A and 5B are cross-sectional views each schematically showing the internal structure of the collection nozzle, and FIG. 6 is a view schematically showing an operation of the collection nozzle. The collection nozzle 4 has a barrier rib 441 disposed in the flow path space S. The barrier rib 441 is provided between the side cover 411 and the side cover 412 in the transfer direction Dm and extended in the Z direction. The barrier rib 441 faces the side cover 411 from the downstream side Dmd and faces the side cover 412 from the upstream side Dmu.

The barrier rib 441 and the side cover 411 stand in the Z direction from both ends of the bottom 421 of the nozzle intake part 42 in the transfer direction Dm, respectively, and a lower end portion of the barrier rib 441 forms a side wall of the nozzle intake part 42 on the downstream side Dmd and a lower end portion of the side cover 411 forms a side wall of the nozzle intake part 42 on the upstream side Dmu. Then, the air intake opening Ani is provided between the lower end of the side cover 411 and the lower end of the barrier rib 441. In the transfer direction Dm, a clearance Ci is formed between the side cover 411 and the barrier rib 441, and the air intake opening Ani faces the clearance Ci from below, to thereby communicates therewith. Further, in the transfer direction Dm, a clearance Co is formed between the side cover 412 and the barrier rib 441. The clearances Ci and Co communicate with each other on the upper side relative to the barrier rib 441. Furthermore, the nozzle exhaust part 43 is connected to an end portion of the clearance Co on the one side Y1, and the clearance Co and the air exhaust opening Ano thereby communicate with each other. Therefore, the airflow Fn reaches the air exhaust opening Ano from the air intake opening Ani passing through the clearance Ci and the clearance Co in this order.

Further, the collection nozzle 4 has a baffle 443 (see FIGS. 4 and 5B) provided at an upper end 442 of the barrier rib 441. The baffle 443 protrudes toward the downstream side Dmd while bending upward from the upper end 442 of the barrier rib 441. In other words, the baffle 443 protrudes into the clearance Co from the barrier rib 441. This baffle 443 is provided one-sidedly on the side of the air exhaust opening Ano (on the one side Y1) with respect to the upper end of the barrier rib 441. In other words, the baffle 443 is provided in a range between a position Pa and a position Pb in the Y direction at the upper end 442 of the barrier rib 441. Herein, the position Pa is a position at an end on the one side Y1 of the upper end 442 of the barrier rib 441, and the position Pb is a position (an intermediate position in this exemplary case) between an end on the one side Y1 and an end on the other side Y2 of the upper end 442 of the barrier rib 441. Therefore, in a range (see FIG. 5A) in which no baffle 443 is provided, the airflow Fn going from the clearance Ci toward the clearance Co is not particularly limited. On the other hand, in a range (see FIG. 5B) in which the baffle 443 is provided, the airflow Fn going from the clearance Ci toward the clearance Co is limited by the baffle 443. As a result, as shown in FIG. 6, in the range near the air exhaust opening Ano in the Y direction, the airflow Fn is limited by the baffle 443, and in the range far away from the air exhaust opening Ano in the Y direction, the airflow Fn is not limited by the baffle 443. By providing such a baffle 443, it is possible to suppress a variation of a suction force in the Y direction, which is supplied to the air intake opening Ani.

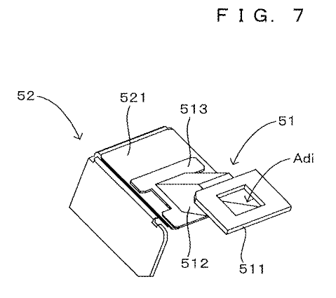

Further, as shown in FIG. 2, the mist collection unit 3 has a plurality of exhaust ducts 5 corresponding to the plurality of collection nozzles 4, and each of the plurality of exhaust ducts 5 is connected to the corresponding collection nozzle 4. The exhaust duct 5 has a an exhaust connector 51 (see FIG. 7) connected to the flange 431 of the corresponding collection nozzle 4.

FIG. 7 is a perspective view schematically showing the exhaust connector of the exhaust duct. The exhaust connector 51 has a flange 511 facing the flange 431 of the collection nozzle 4 from below. Further, the exhaust connector 51 has a duct opening Adi which is opened upward in the flange 511. In other words, the flange 511 is so provided as to protrude sideward from the duct opening Adi. Furthermore, the exhaust connector 51 has a connector pipe 512 extended downward from the flange 511, and the connector pipe 512 communicates with the duct opening Adi. The connector pipe 512 is extended, being so inclined as to go toward the one side X1 in the X direction as it goes downward. Further, the exhaust connector 51 has a flange 513 provided at a lower end of the connector pipe 512. At least the flange 513 among the flange 511 at an upper end of the exhaust duct 5 and the flange 513 at the lower end thereof is positioned below the printing medium M supported by the rollers 201 of the transfer part 2.

Furthermore, the exhaust duct 5 has a stay 52 for attaching the exhaust connector 51 to the support plate 202 of the transfer part 2. The stay 52 is attached to the support plate 202 directly or with a beam or the like therebetween. This stay 52 has an attachment plate 521 supported horizontally. The flange 513 of the exhaust connector 51 comes into contact with the attachment plate 521 of the stay 52 from above and is fastened to the attachment plate 521 with a screw or the like. Thus, the exhaust connector 51 of the exhaust duct 5 is attached to the support plate 202 of the transfer part 2 with the stay 52 interposed therebetween.

Further, the exhaust duct 5 has an exhaust pipe 53 (see FIG. 2) attached to the lower end of the connector pipe 512. The exhaust pipe 53 is disposed below the printing medium M supported by the rollers 201 of the transfer part 2. In the attachment plate 521, a through hole which is opened to the connector pipe 512 is provided, and an upper end of the exhaust pipe 53 is attached to the lower end of the connector pipe 512 from below through the through hole. Thus, the exhaust pipe 53 is extended downward from the lower end of the connector pipe 512. This exhaust pipe 53 communicates with the duct opening Adi with the connector pipe 512 interposed therebetween.

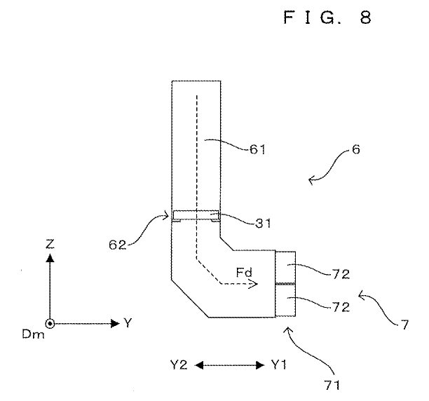

Further, as shown in FIG. 8, the mist collection unit 3 has a mist removing part 6 and a suction part 7. FIG. 8 is a side elevational view schematically showing the mist removing part and the suction part. The mist removing part 6 and the suction part 7 are disposed below the printing medium M supported by the rollers 201 of the transfer part 2 and face the printing medium M from below.

Each of the plurality of exhaust ducts 5 is connected to the suction part 7 through the mist removing part 6. Specifically, a lower end of the exhaust pipe 53 in each of the plurality of exhaust ducts 5 is connected to the mist removing part 6. The mist removing part 6 has a mist removing pipe 61 connecting a lower end of the exhaust duct 5 to the suction part 7 and a filter attachment part 62 provided for the mist removing pipe 61, and the filter 31 is detachable/attachable from the one side Y1 in the Y direction from/to the filter attachment part 62. The filter attachment part 62 is, for example, a projection protruding inward inside the mist removing pipe 61, and the filter 31 can be attached to the filter attachment part 62 by placing the filter 31 on this projection. Further, though one mist removing pipe 61 and one filter 31 are provided common to the plurality of exhaust ducts 5 herein, one mist removing pipe 61 and one filter 31 may be provided individually for each of the plurality of exhaust ducts 5.

Furthermore, the suction part 7 has a plurality of fan units 71 corresponding to the plurality of exhaust ducts 5, respectively, and each of the plurality of exhaust ducts 5 is connected to the corresponding fan unit 71 by the mist removing pipe 61. Each fan unit 71 has two suction fans 72, and a suction force for sucking air from the mist removing pipe 61 is generated by the two suction fans 72.

When this fan unit 71 starts and the suction fans 72 rotate, the airflow Fd reaching the suction part 7 from the duct opening Adi through the connector pipe 512, the exhaust pipe 53, and the mist removing pipe 61 is generated and the duct opening Adi is sucked by this airflow Fd. Thus, the suction force generated by the fan unit 71 is supplied to the duct opening Adi through the mist removing pipe 61, the exhaust pipe 53, and the connector pipe 512. As described above, the air exhaust opening Ano faces the duct opening Adi from above. Therefore, the air exhaust opening Ano is sucked by the suction force supplied to the duct opening Adi, and the airflow Fn (see FIGS. 5A and 5B) reaching the air exhaust opening Ano from the air intake opening Ani through the flow path space S is thereby formed. As a result, the ink mist sucked from the air intake opening Ani is carried by the airflow Fn to reach the duct opening Adi,. Further, the ink mist reaching the duct opening Adi goes from the duct opening Adi toward the fan unit 71, being carried by the airflow Fd. Furthermore, at some midpoint of the airflow Fd going from the duct opening Adi toward the fan unit 71, the filter 31 is present. Therefore, the ink mist carried by the airflow Fd is removed from the airflow Fd by the filter 31.

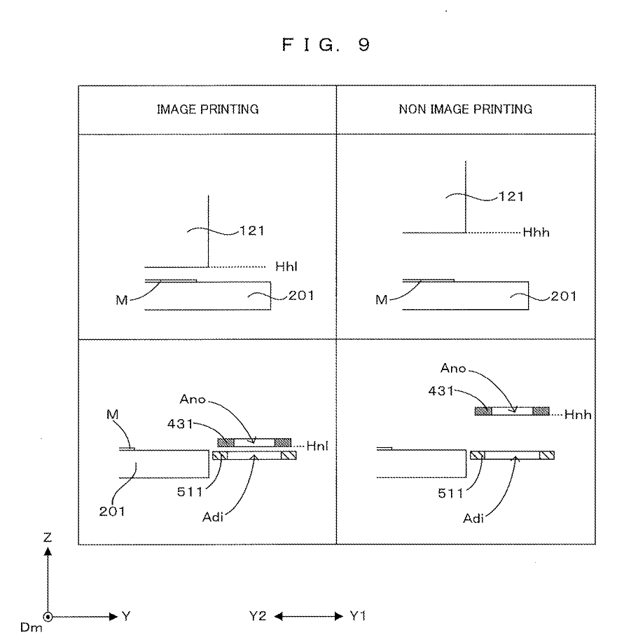

Further, the printer 1 includes a lifting/lowering driving mechanism 17 for lifting and lowering the base frame 14 which fixes the collection nozzle 4 to the ejection head 121. This lifting/lowering driving mechanism 17 has a lifting/lowering plate 171 attached to the base frame 14 and an actuator 172 for lifting and lowering the lifting/lowering plate 171. Then, when the actuator 172 lifts the lifting/lowering plate 171, the lifting/lowering plate 171 is lifted together with the ejection head 121 and the collection nozzle 4. Further, when the actuator 172 lowers the lifting/lowering plate 171, the lifting/lowering plate 171 is lowered together with the ejection head 121 and the collection nozzle 4. As a result, the operation shown in FIG. 9 is performed.

FIG. 9 is a partial sectional view schematically and emphatically showing an operation performed by lifting or lowering the ejection head and the collection nozzle. As shown in FIG. 9, the ejection head 121 is driven in the Z direction by the actuator 172 between a print height Hhl and a non-print height Hhh higher than the print height Hhl (in other words, farther from the printing medium M). Further, the flange 431 is driven in the Z direction by the actuator 172 between a proximity height Hnl and a separation height Hnh higher than the proximity height Hnl (in other words, farther from the flange 511).

In image printing in which the ejection head 121 ejects color ink onto the printing medium M to print a color image, the actuator 172 lowers the ejection head 121 and the collection nozzle 4. As a result, as shown in the column of "IMAGE PRINTING" of FIG. 9, the ejection head 121 is positioned at the print height Hhl, and ejects ink onto the printing medium M while facing the printing medium M supported by the roller 201 from above. In this image printing, the flange 431 of the collection nozzle 4 is positioned at the proximity height Hnl and faces the flange 511 from above. The air exhaust opening Ano thereby faces the duct opening Adi at the proximity height Hnl. Further, the suction part 7 operates the suction fans 72 of the fan unit 71 to make the suction fans 72 generate the suction force. At that time, the flange 431 positioned at the proximity height Hnl and the flange 511 are separated from each other and there is a clearance left therebetween in the Z direction. For this reason, there is a clearance left also between the air exhaust opening Ano positioned at the proximity height Hnl and the duct opening Adi in the Z direction. Since this clearance is very small, however, the suction force supplied to the duct opening Adi by the suction part 7 is sufficiently transmitted to the air exhaust opening Ano, to thereby generate the above-described airflow Fn. As a result, the ink mist generated in the image printing is collected to the filter 31 from the air intake opening Ani of the collection nozzle 4 by the airflow Fn and the airflow Fd.

In non-image printing in which the ejection head 121 does not perform the color image printing, the actuator 172 lifts the ejection head 121 and the collection nozzle 4. As a result, as shown in the column of "NON IMAGE PRINTING" of FIG. 9, the ejection head 121 is positioned at the non-print height Hhh and separated upward from the printing medium M supported by the roller 201. In this non-image printing, the flange 431 of the collection nozzle 4 is positioned at the separation height Hnh and separated upward from the flange 511.

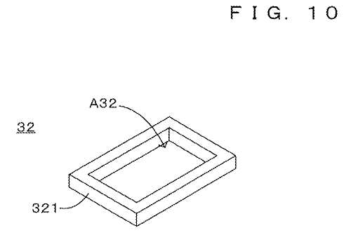

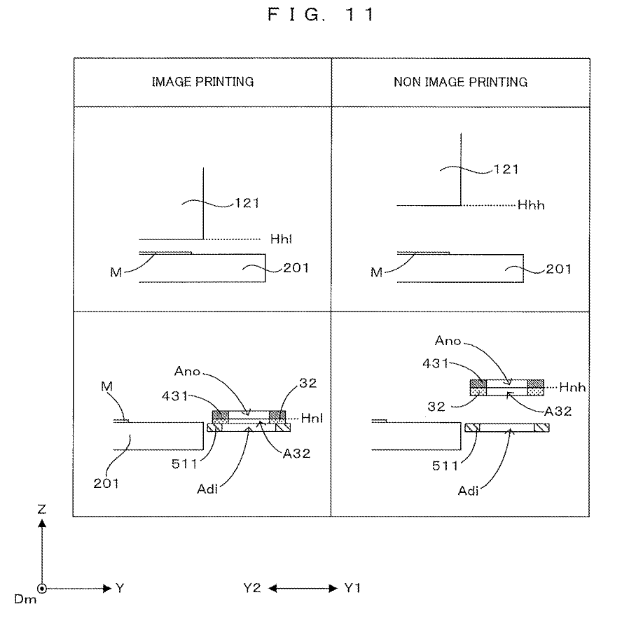

In the above-described exemplary case, any member is not particularly provided between the flange 431 of the nozzle exhaust part 43 and the flange 511 of the exhaust connector 51. On the other hand, a cushioning material 32 (see FIGS. 10 and 11) may be provided therebetween.

FIG. 10 is a perspective view schematically showing an appearance structure of the cushioning material, and FIG. 11 is a partial sectional view schematically and emphatically showing an operation performed by lifting or lowering the ejection head and the collection nozzle in a configuration including the cushioning material. Since a difference between the exemplary operation shown in FIG. 9 and that shown in FIG. 11 lies in whether or not the cushioning material 32 is provided, description will be made, centering on the difference between these exemplary operations, and the common parts are represented by corresponding reference signs and description thereof will be omitted as appropriate.

The cushioning material 32 is formed of sponge or rubber, and includes a frame body 321 surrounding a communication opening A32 penetrating the cushioning material 32 in the Z direction. In other words, at the center of the cushioning material 32, provided is the communication opening A32. This cushioning material 32 is provided between the flange 431 and the flange 511 and bonded to a bottom surface of the flange 431. In a state where the flange 431 is positioned at the separation height Hnh in the non-image printing, the cushioning material 32 is separated upward from the flange 511.

On the other hand, in a state where the flange 431 is positioned at the proximity height Hnl in the image printing, the cushioning material 32 is in contact with an upper surface of the flange 511. Particularly, the cushioning material 32 is in contact with both the bottom surface of the flange 431 and the upper surface of the flange 511 and is crushed by the flange 431 and the flange 511, to be thereby deformed. In other words, the clearance between the flange 431 and the flange 511 is filled with the cushioning material 32. In this image printing, the communication opening A32 faces the air exhaust opening Ano from below and faces the duct opening Adi from above, and the air exhaust opening Ano and the duct opening Adi communicate with each other through the communication opening A32.

As described above, in the image printing, the suction part 7 operates the suction fans 72 of the fan unit 71, to thereby make the suction fans 72 generate the suction force. The suction force supplied to the duct opening Adi by the suction part 7 is transmitted to the air exhaust opening Ano through the communication opening A32, to thereby generate the above-described airflow Fn. As a result, the ink mist generated in the image printing is collected to the filter 31 from the air intake opening Ani of the collection nozzle 4 by the airflow Fn and the airflow Fd.

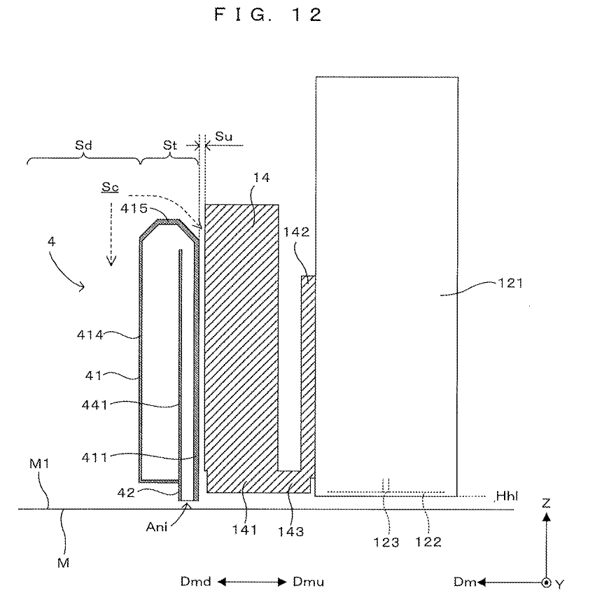

FIG. 12 is a partial sectional view schematically showing a positional relation between the base frame supporting the ejection head and the collection nozzle. The base frame 14 has a base plate 141 standing in the Z direction, a support plate 142 standing in the Z direction on the upstream side Dmu relative to the base plate 141, and a bottom plate 143 supporting the support plate 142 with respect to the base plate 141. These plates 141, 142, and 143 may be formed as a unit or formed separately as different units.

The ejection head 121 is disposed on the upstream side Dmu of the support plate 142 and attached to a side surface of the support plate 142 on the upstream side Dmu. Further, the collection nozzle 4 is disposed on the downstream side Dmd of the base plate 141 and attached to a side surface of the base plate 141 on the downstream side Dmd with a space (space Su) left therebetween. The base frame 14 faces the printing medium M with a space left therebetween from above, and the ejection head 121 and the collection nozzle 4 which are supported by the base frame 14 also face the printing medium M with a space left therebetween from above.

Furthermore, as described above, the base frame 14 is attached to the lifting/lowering plate 171 of the lifting/lowering driving mechanism 17, and the base frame 14, the ejection head 121, and the collection nozzle 4 are lifted and lowered by the lifting/lowering driving mechanism 17. FIG. 12 shows a state in the image printing where the ejection head 121 is positioned at the print height Hhl. As shown in FIG. 12, the ejection head 121 has a nozzle opening surface 122 facing the printing medium M from above. In the nozzle opening surface 122, an ejection nozzle 123 is opened to the front surface M1 of the printing medium M and ejects ink toward the front surface M1.

In the transfer direction Dm, a space Su is provided on the upstream side Dmu of the collection nozzle 4, and a space Sd is provided on the downstream side Dmd of the collection nozzle 4. In other words, in the transfer direction Dm, the space Su is left on the upstream side Dmu of the collection nozzle 4 (the nozzle housing 41), i.e., between the collection nozzle 4 (the nozzle housing 41) and the base plate 141, and air is flowable in the space Su. This space Su is provided over a range from the lower side relative to the lower end of the collection nozzle 4 (the lower end of the nozzle intake part 42) to the upper side relative to the upper end of the collection nozzle 4 (the upper end of the top cover 415) in the Z direction. Further, in the transfer direction Dm, the space Sd is left on the downstream side Dmd relative to the collection nozzle 4 (the nozzle housing 41), and air is flowable in the space Sd. This space Sd is provided over a range from the lower side relative to the lower end of the collection nozzle 4 (the lower end of the nozzle intake part 42) to the upper side relative to the upper end of the collection nozzle 4 (the upper end of the top cover 415) in the Z direction. The space Su and the space Sd are connected to each other with a space St on the upper side of the upper end of the collection nozzle 4 (the top cover 415) interposed therebetween.

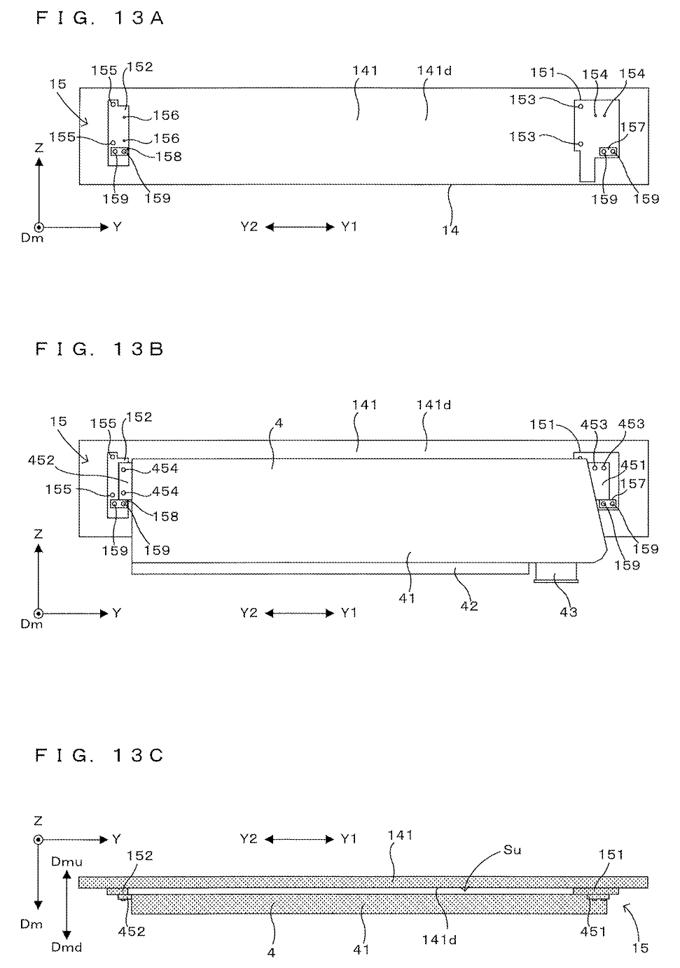

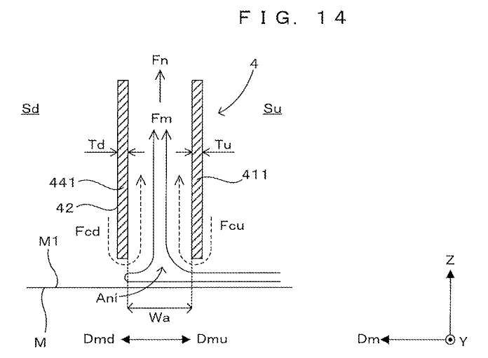

FIGS. 13A to 13C are views each schematically showing an attachment mechanism of the collection nozzle to the base frame supporting the ejection head. As shown in these figures, the printer 1 includes an attachment mechanism 15 for attaching the collection nozzle 4 to the base frame 14. This attachment mechanism 15 has two spacer plates 151 and 152 attached to the base plate 141 of the base frame 14. Specifically, a side surface 141d of the base plate 141 on the downstream side Dmd is a plane orthogonal to the transfer direction Dm, and a pair of spacer plates 151 and 152 are fixed to the side surface 141d of the base plate 141 with a space left therebetween in the Y direction.

Among the two spacer plates 151 and 152, the spacer plate 151 on the one side Y1 is fastened to the side surface 141d with two screws 153 arranged in the Z direction. In this spacer plate 151, provided are two screw holes 154 arranged in the Y direction, and each of the screw holes 154 penetrates the spacer plate 151 in the transfer direction Dm. Further, the spacer plate 152 on the other side Y2 is fastened to the side surface 141d with two screws 155 arranged in the Z direction. In this spacer plate 152, provided are two screw holes 156 arranged in the Z direction, and each of the screw holes 156 penetrates the spacer plate 152 in the transfer direction Dm. Thus, the two spacer plates 151 and 152 protrude toward the downstream side Dmd from the side surface 141d of the base plate 141.

Furthermore, the attachment mechanism 15 has two support plates 157 and 158 provided corresponding to the two spacer plates 151 and 152, respectively. The support plate 157 is fastened to a side surface of the spacer plate 151 on the downstream side Dmd with two screws 159 arranged in the Y direction. Thus, the support plate 157 protrudes toward the downstream side Dmd from the side surface of the spacer plate 151. The support plate 158 is fastened to a side surface of the spacer plate 152 on the downstream side Dmd with the two screws 159 arranged in the Y direction. Thus, the support plate 158 protrudes toward the downstream side Dmd from the side surface of the spacer plate 152.

On the other hand, the collection nozzle 4 has two attachment plates 451 and 452 provided, protruding from both ends of the nozzle housing 41 in the Y direction. The two attachment plates 451 and 452 are provided corresponding to the two spacer plates 151 and 152. In the transfer direction Dm, each of the attachment plates 451 and 452 is provided with respect to an end of the nozzle housing 41 on the upstream side Dmu, and the side surfaces of the attachment plates 451 and 452 on the downstream side Dmd and the side surface of the nozzle housing 41 on the downstream side Dmd are flush with one another. It is not indispensable, however, that these side surfaces are flush with one another, but the attachment plates 451 and 452 may protrude toward the upstream side Dmu with respect to the nozzle housing 41.

The attachment plate 451 protrudes toward the one side Y1 from an end of the nozzle housing 41 on the one side Y1. This attachment plate 451 is fastened to the spacer plate 151 with two screws 453 arranged in the Y direction. Specifically, the two screws 453 are screwed into the two screw holes 154, respectively, which are opened in the spacer plate 151, to thereby attach the attachment plate 451 to the spacer plate 151. Further, the support plate 157 comes into contact with the attachment plate 451 attached to the spacer plate 151 from below.

The attachment plate 452 protrudes toward the other side Y2 from an end of the nozzle housing 41 on the other side Y2. This attachment plate 452 is fastened to the spacer plate 152 with two screws 454 arranged in the Z direction. Specifically, the two screws 454 are screwed into the two screw holes 156, respectively, which are opened in the spacer plate 152, to thereby attach the attachment plate 452 to the spacer plate 152. Further, the support plate 158 comes into contact with the attachment plate 452 attached to the spacer plate 152 from below.

Thus, the collection nozzle 4 is attached to the base plate 141 via the two spacer plates 151 and 152 disposed with a space left in the Y direction. The spacer plates 151 and 152 come into contact with the base plate 141 on the respective upstream sides Dmu thereof and come into contact with the collection nozzle 4 (the attachment plates 451 and 452) on the respective downstream sides Dmd thereof. With these spacer plates 151 and 152, the space Su is ensured between the base plate 141 and the collection nozzle 4. In other words, between the collection nozzle 4 and the base plate 141, the space Su is formed by the spacer plates 151 and 152.

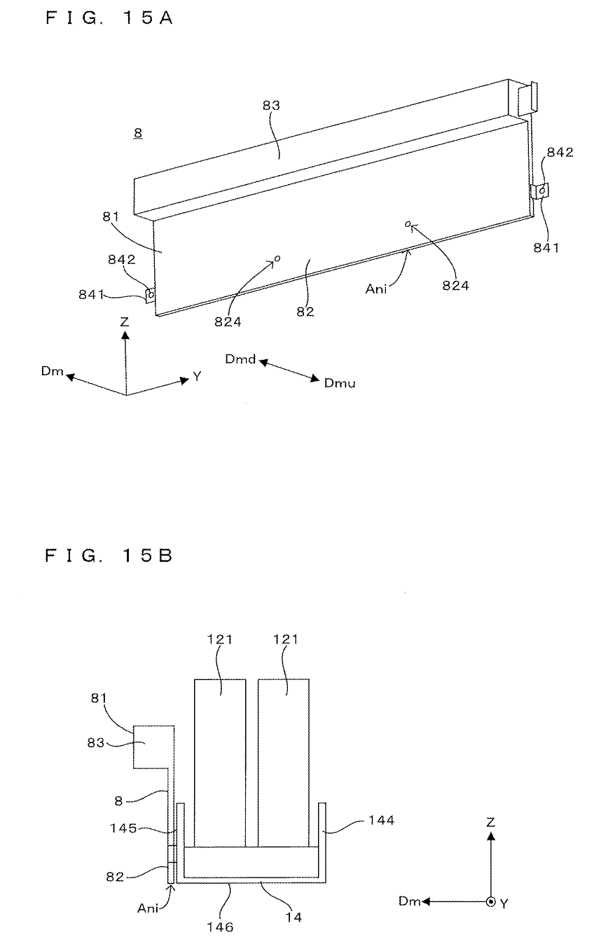

FIG. 14 is a partial sectional view schematically showing respective functions of the spaces provided on both the sides of the collection nozzle. In the exemplary case shown in FIG. 14, like in the above-described case, the side cover 411 and the barrier rib 441 are extended in the Z direction in parallel with each other, and the air intake opening Ani is opened between the respective lower ends of the side cover 411 and the barrier rib 441.

When the air intake opening Ani is sucked and the above-described airflow Fn is generated in the flow path space S of the collection nozzle 4 (see FIGS. 5A and 5B), a clean airflow Fcu flowing into the air intake opening Ani from the space Su is generated. Specifically, a negative pressure is given to the space Su from below, accompanying the suction of the air intake opening Ani, and the clean airflow Fcu is thereby generated. This clean airflow Fcu goes down in the space Su along an outer wall of the side cover 411 and reaches the lower side of the nozzle intake part 42, and then flows into the air intake opening Ani. Thus, the clean airflow Fcu flowing into the air intake opening Ani goes up along an inner wall of the side cover 411 (a wall on the downstream side Dmd). As a result, inside the nozzle housing 41 of the collection nozzle 4, generated is a layer of the clean airflow Fcu going up along the side cover 411 from the air intake opening Ani.

Similarly, when the airflow Fn is generated, accompanying the suction of the air intake opening Ani, a clean airflow Fcd flowing into the air intake opening Ani from the space Sd is generated. Specifically, a negative pressure is given to the space Sd from below, accompanying the suction of the air intake opening Ani, and the clean airflow Fcd is thereby generated. This clean airflow Fcd goes down in the space Sd along an outer wall of the side cover 412 and the barrier rib 441 and reaches the lower side of the nozzle intake part 42, and then flows into the air intake opening Ani. Thus, the clean airflow Fcd flowing into the air intake opening Ani goes up along an inner wall of the barrier rib 441 (a wall on the upstream side Dmu). Thus, inside the nozzle housing 41 of the collection nozzle 4, generated is a layer of the clean airflow Fcd going up along the barrier rib 441 from the air intake opening Ani.

Further, in the space Sd, a space Sc on the upper side relative to the collection nozzle 4 is sufficiently far away from between the ejection head 121 which is a source of the ink mist and the printing medium M. For this reason, air in the space Sc is clean air containing almost no ink mist. On the other hand, the clean airflow Fcu flows into the space Su from the space Sc through the space St, and then flows into the air intake opening Ani. Further, the clean airflow Fcd flows into the air intake opening Ani from the space Sc through the lower side relative to the space Sc in the space Sd. Therefore, the clean airflow Fcu and the clean airflow Fcd supply clean air in the space Sc to the air intake opening Ani.

Furthermore, when the airflow Fn is generated with accompanying the suction of the air intake opening Ani, a mist collection airflow Fm for collecting the ink mist is generated. This mist collection airflow Fm contains an ink mist generated when the ejection head 121 on the upstream side Dmu of the collection nozzle 4 ejects ink onto the front surface M1 of the printing medium M. When the airflow Fn reaches the air intake opening Ani along the printing medium M from the upstream side Dmu of the collection nozzle 4, the airflow Fn flows into the air intake opening Ani. Thus, the mist collection airflow Fm having flowed into the air intake opening Ani goes up between the clean airflow Fcu and the clean airflow Fcd.

In the embodiment described above, the space Su (first space) and the space Sd (second space) are provided on both the sides of the transfer direction Dm of the collection nozzle 4. The clean airflow Fcu (first airflow) going from the upper side (one side) toward the lower side (other side) in the space Su is generated by giving the pressure for generating the clean airflow Fcu to the space Su from only the lower side among the upper side and the lower side. Further, the clean airflow Fcd (second airflow) going from the upper side toward the lower side in the space Sd is generated by giving the pressure for generating the clean airflow Fcd to the space Sd from only the lower side among the upper side and the lower side. At that time, the pressure for generating the clean airflow Fcu and the pressure for generating the clean airflow Fcd are generated by the collection nozzle 4 sucking air from the air intake opening Ani. Then, the clean airflow Fcu having flowed out from the space Su toward the lower side flows into the collection nozzle 4 from the air intake opening Ani, and the clean airflow Fcd having flowed out from the space Sd toward the lower side flows into the collection nozzle 4 from the air intake opening Ani.

Thus, the clean airflow Fcu is generated in the space Su by giving the pressure caused by an airflow generated by the collection nozzle 4 sucking from the air intake opening Ani, to the space Su only from the lower side, without giving any pressure to the space Su from the upper side. The relatively moderate clean airflow Fcu is thereby generated. When such a clean airflow Fcu flows into the collection nozzle 4 from the air intake opening Ani, a layer of the clean airflow Fcu is generated along the inner wall of the collection nozzle 4 on the side of the space Su. Similarly, the clean airflow Fcd is generated in the space Sd by giving the pressure caused by an airflow generated by the collection nozzle 4 sucking from the air intake opening Ani, to the space Sd only from the lower side, without giving any pressure to the space Sd from the upper side. The relatively moderate clean airflow Fcd is thereby generated. When such a clean airflow Fcd flows into the collection nozzle 4 from the air intake opening Ani, a layer of the clean airflow Fcd is generated along the inner wall of the collection nozzle 4 on the side of the space Sd. Then, the mist collection airflow Fm containing the ink mist sucked from the air intake opening Ani goes through between the layers on both the sides. As a result, adhesion of the ink mist onto the inner wall of the collection nozzle 4 is suppressed. Thus, it becomes possible to suppress adhesion of the ink onto the collection nozzle 4 which sucks the ink mist to collect the ink mist.

Further, it is favorable that the width Wa (size) of the air intake opening Ani in the transfer direction Dm should be specifically larger than 2 mm and smaller than 7 mm (see FIG. 14). It is thereby possible to effectively suppress adhesion of the ink mist onto the inner wall of the collection nozzle 4.

Furthermore, the ejection head 121 has the nozzle opening surface 122 facing the printing medium M and the ejection nozzle 123 which is opened in the nozzle opening surface 122, and ejects ink onto the printing medium M from the ejection nozzle 123. On the other hand, the space Su is provided over a range from the printing medium M transferred by the transfer part 2 (printing medium transfer part) up to the upper side (one side) relative to the nozzle opening surface 122 (see FIG. 12). In such a configuration, a layer of relatively clean airflow (clean airflow Fcu) is generated along the inner wall of the collection nozzle 4, and it is thereby possible to effectively suppress adhesion of the ink mist onto the inner wall of the collection nozzle 4.

Further, the space Sd is provided over a range from the printing medium M transferred by the transfer part 2 up to the upper side (one side) relative to the nozzle opening surface 122. In such a configuration, a layer of relatively clean airflow (clean airflow Fcd) is generated along the inner wall of the collection nozzle 4, and it is thereby possible to effectively suppress adhesion of the ink mist onto the inner wall of the collection nozzle 4.

Furthermore, the collection nozzle 4 has the side cover 411 (first standing plate) standing upward (toward the one side) from the air intake opening Ani on the upstream side Dmu of the air intake opening Ani in the transfer direction Dm and the barrier rib 441 (second standing plate) standing upward (toward the one side) from the air intake opening Ani on the downstream side Dmd of the air intake opening Ani in the transfer direction Dm. On the other hand, it is favorable that in the transfer direction Dm, the thickness Tu of the side cover 411 should be smaller than 2 mm and the thickness Td of the barrier rib 441 should be smaller than 2 mm (see FIG. 14). Thus, since the side cover 411 and the barrier rib 441 are each formed to be thin, it is possible to suppress the effect of the respective thicknesses Tu and Td of the side cover 411 and the barrier rib 441 and reliably generate the layer of the clean airflow Fcu and the layer of the clean airflow Fcd along the inner wall of the collection nozzle 4. As a result, it is possible to effectively suppress adhesion of the ink mist onto the inner wall of the collection nozzle 4.

Further, in the transfer direction Dm, the thickness Tu of the side cover 411 is smaller than the width Wa of the air intake opening Ani and the thickness Td of the barrier rib 441 is smaller than the width Wa of the air intake opening Ani. Thus, since the side cover 411 and the barrier rib 441 are each formed to be thin, it is possible to suppress the effect of the respective thicknesses Tu and Td of the side cover 411 and the barrier rib 441 and reliably generate the layer of the clean airflow Fcu and the layer of the clean airflow Fcd along the inner wall of the collection nozzle 4. As a result, it is possible to effectively suppress adhesion of the ink mist onto the inner wall of the collection nozzle 4.

Furthermore, the space Su is provided over a range from the printing medium M transferred by the transfer part 2 up to the upper side (the one side) relative to the upper end of the collection nozzle 4. In such a configuration, a layer of relatively clean airflow (clean airflow Fcu) is generated along the inner wall of the collection nozzle 4, and it is thereby possible to effectively suppress adhesion of the ink mist onto the inner wall of the collection nozzle 4.

Further, the space Sd is provided over a range from the printing medium M transferred by the transfer part 2 up to the upper side (the one side) relative to the upper end of the collection nozzle 4. In such a configuration, a layer of relatively clean airflow (clean airflow Fcd) is generated along the inner wall of the collection nozzle 4, and it is thereby possible to effectively suppress adhesion of the ink mist onto the inner wall of the collection nozzle 4.

Furthermore, the space Su and the space Sd are connected to each other with the space St on the upper side (the one side) relative to the upper end of the collection nozzle 4 interposed therebetween. In such a configuration, a layer of relatively clean airflow (clean airflow Fcu) is generated along the inner wall of the collection nozzle 4, and it is thereby possible to effectively suppress adhesion of the ink mist onto the inner wall of the collection nozzle 4.

Further, the base frame 14 (head support member) supporting the ejection head 121 and the attachment mechanism 15 (nozzle support member) supporting the collection nozzle 4 with respect to the base frame 14 are provided. The base frame 14 has the base plate 141 (side wall plate) positioned between the ejection head 121 and the collection nozzle 4 in the transfer direction Dm. On the other hand, the attachment mechanism 15 supports the collection nozzle 4 with the space Su left between the base plate 141 and the collection nozzle 4 (see FIGS. 13A to 13C). In such a configuration, adhesion of the ink mist onto the inner wall of the collection nozzle 4 is suppressed. For this reason, it becomes possible to suppress adhesion of the ink onto the collection nozzle 4 which sucks the ink mist to collect the ink mist.

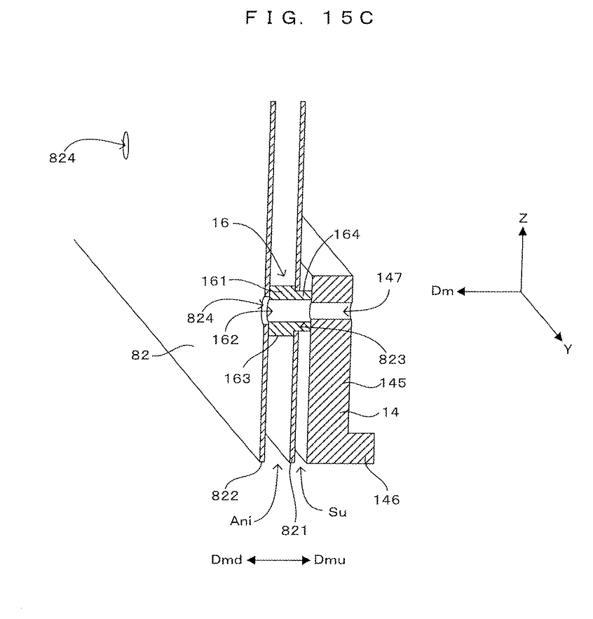

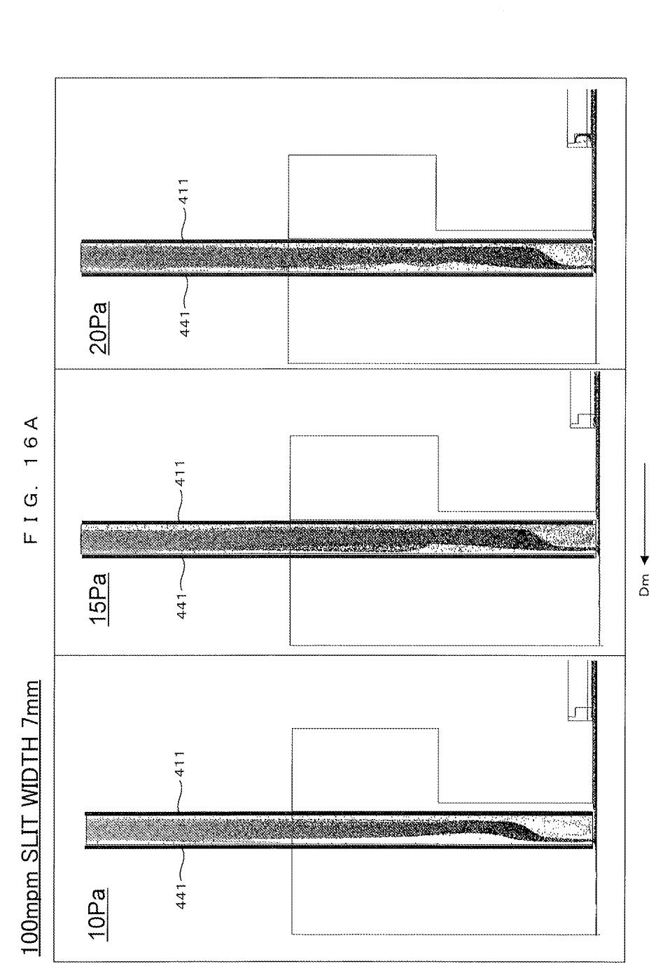

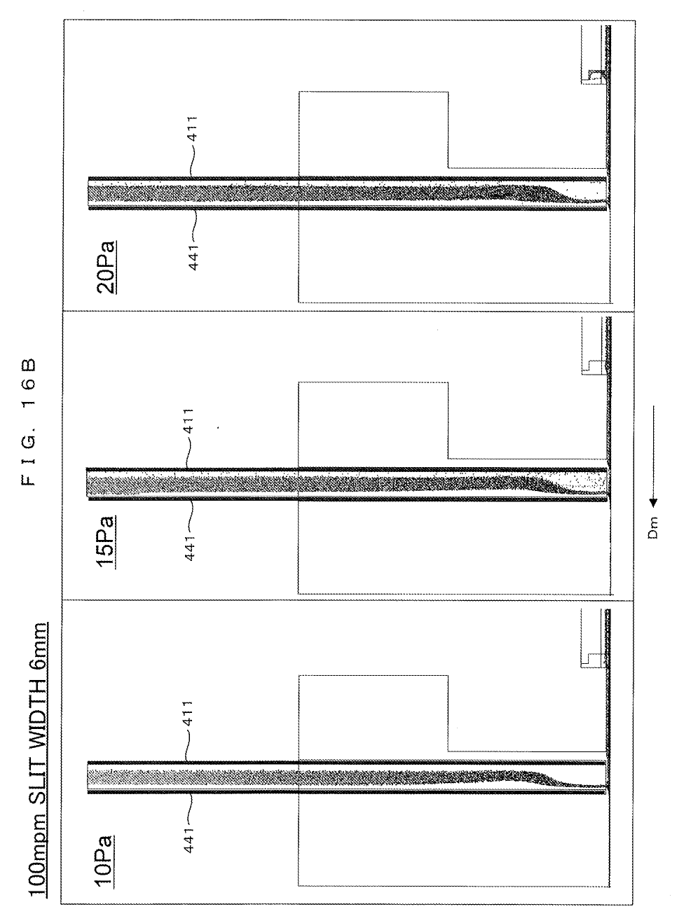

Specific configuration of the collection nozzle 4 and the attachment mechanism 15 may be changed as appropriate. Then, there may be a configuration shown in FIGS. 15A to 15C. FIG. 15A is a perspective view schematically showing a variation of the collection nozzle, FIG. 15B is a view schematically showing a variation of a mechanism for supporting the collection nozzle shown in FIG. 15A with respect to the ejection head, and FIG. 15C is a partial sectional view schematically showing the variation of the mechanism for supporting the collection nozzle shown in FIG. 15A with respect to the ejection head.

Like the collection nozzle 4 described above, a collection nozzle 8 shown in FIG. 15A is disposed on the downstream side Dmd of the ejection head 121 in the transfer direction Dm and sucks the ink mist. This collection nozzle 8 has a nozzle housing 81. The nozzle housing 81 has a nozzle intake part 82 having the air intake opening Ani at a lower end thereof and a nozzle exhaust part 83 connected to an exhaust duct for exhausting the nozzle intake part 82. The nozzle exhaust part 83 is provided at an upper end of the nozzle housing 81, and the nozzle intake part 82 is extended from the nozzle exhaust part 83 toward the lower side thereof. Further, the nozzle exhaust part 83 protrudes from the nozzle intake part 82 toward the downstream side Dmd in the transfer direction Dm. When a suction force is given to the nozzle exhaust part 83 through the exhaust duct, this collection nozzle 8 sucks the ink mist from the air intake opening Ani which is opened at the lower end of the nozzle intake part 82.

The nozzle intake part 82 has two side plates 821 and 822. Each of the side plates 821 and 822 is a flat plate orthogonal to the transfer direction Dm. The side plates 821 and 822 face each other with a space left in the transfer direction Dm, and the side plate 821 is positioned on the upstream side Dmu relative to the side plate 822. The air intake opening Ani is provided between the respective lower ends of the side plates 821 and 822. Therefore, the airflow flowing into the collection nozzle 4 from the air intake opening Ani goes upward between the side plates 821 and 822 and reaches the nozzle exhaust part 83.

The base frame 14 supporting the ejection head 121 has two side plates 144 and 145 which are provided with a space left therebetween in the transfer direction Dm and a bottom plate 146 for connecting respective lower ends of the side plates 144 and 145 to each other. The ejection head 121 is placed onto the bottom plate 146 from above between the side plates 144 and 145. Thus, the ejection head 121 is supported by the bottom plate 146 of the base frame 14.

An attachment mechanism 16 for attaching the collection nozzle 8 to the base frame 14 is provided. The attachment mechanism 16 attaches the collection nozzle 8 to the side plate 145 on the downstream side Dmd, among the two side plates 144 and 145. The attachment mechanism 16 has a spacer 161, and the spacer 161 is provided with a screw hole 162 penetrating the spacer 161 in the transfer direction Dm. This spacer 161 has a large diameter part 163 disposed between the side plate 821 and the side plate 822 and a small diameter part 164 protruding from the large diameter part 163 toward the upstream side Dmu. The diameter of an outer peripheral surface of the large diameter part 163 is larger than that of the small diameter part 164, and the large diameter part 163 protrudes from the small diameter part 164 in a flange manner.

The large diameter part 163 is sandwiched between the side plates 821 and 822, and comes into contact with the side plate 821 on the upstream side Dmu thereof and comes into contact with the side plate 822 on the downstream side Dmd thereof. In other words, a space is ensured between the side plate 821 and side plate 822 by the large diameter part 163.

In the side plate 821, provided is an insertion hole 823 corresponding to the small diameter part 164 of the spacer 161 in the transfer direction Dm. In response, the small diameter part 164 is inserted into the insertion hole 823 and protrudes from the side plate 821 toward the upstream side Dmu. An end of this side plate 821 on the upstream side Dmu comes into contact with the side plate 145 of the base frame 14 from the downstream side Dmd. In other words, the space Su is ensured between the side plate 821 and the side plate 145 by the small diameter part 164.

Further, the side plate 822 of the collection nozzle 8 is provided with an insertion hole 824 facing the screw hole 162 of the spacer 161. Furthermore, the side plate 145 of the base frame 14 is provided with a screw hole 147 facing the screw hole 162 of the spacer 161. Then, a screw inserted into the insertion hole 824 and the screw holes 162 and 147 from the downstream side Dmd is screwed into the screw hole 147. Thus, the collection nozzle 8 is attached to the base frame 14 by the attachment mechanism 16.

Further, the collection nozzle 8 has two attachment plates 841 provided, protruding from both ends of the nozzle housing 81 in the Y direction. Each of the attachment plates 841 is provided with an insertion hole 842. Then, by screwing a screw inserted into the insertion hole 842 from the downstream side Dmd, into the side plate 145, the collection nozzle 8 is attached to the base frame 14.

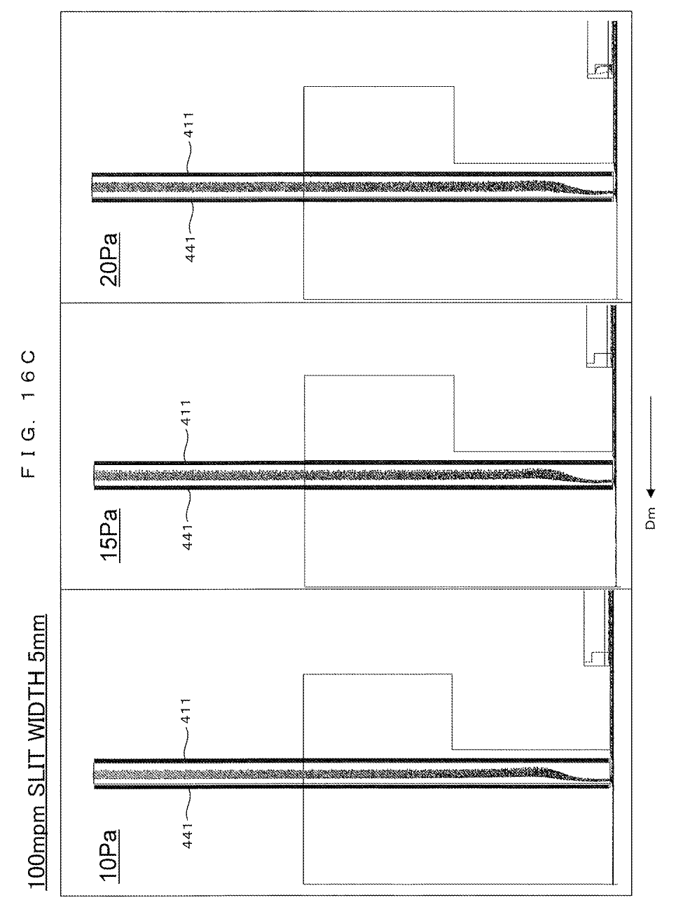

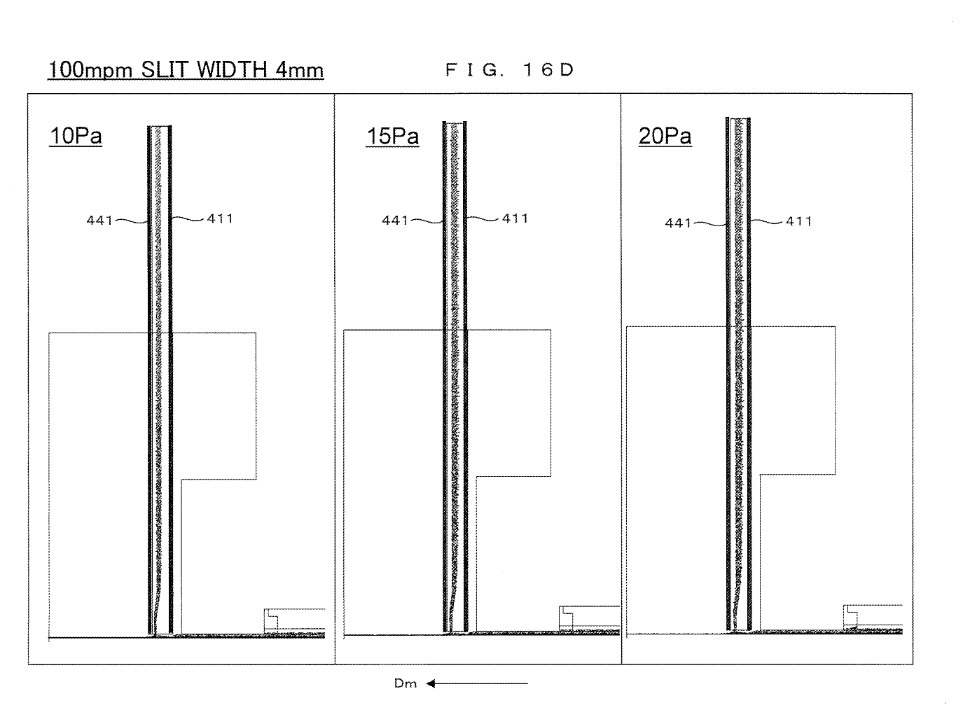

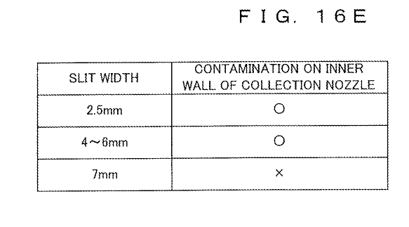

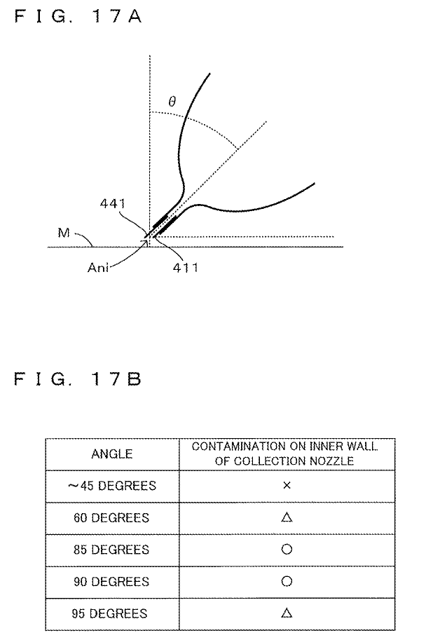

FIGS. 16A to 16D are views each showing a simulation result of a diffusion manner of the ink mist sucked into the collection nozzle. In each figure, dots represent the ink mist. Each figure shows respective results obtained when the pressure for sucking the air intake opening Ani is 10 Pa, 15 Pa, and 20 Pa in a case where the transfer speed of the printing medium M in the transfer direction Dm is 100 mpm (meter per minute) and the width of the space Su in the transfer direction Dm is 2 mm. Further, FIG. 16A shows a simulation result in a case where the width (slit width) of the air intake opening Ani in the transfer direction Dm is 7 mm, FIG. 16B shows a simulation result in a case where the width (slit width) of the air intake opening Ani in the transfer direction Dm is 6 mm, FIG. 16C shows a simulation result in a case where the width (slit width) of the air intake opening Ani in the transfer direction Dm is 5 mm, and FIG. 16D shows a simulation result in a case where the width (slit width) of the air intake opening Ani in the transfer direction Dm is 4 mm.

From these results, it can be seen that a layer of clean air is clearly formed on each of the inside of the side cover 411 and the inside of the barrier rib 441 when the width Wa (slit width) of the air intake opening Ani is in a range from 4 mm to 6 mm in a case where a suction pressure is in a range from 10 Pa to 20 Pa. On the other hand, when the width Wa of the air intake opening Ani is 7 mm, it can be seen that there occurs a disturbance in this layer of clean air. Therefore, it is favorable that the width Wa of the air intake opening Ani should be smaller than 7 mm.

FIG. 16E is a view showing whether the width of the air intake opening is suitable or not in a table form. This table shows the width (slit width) of the air intake opening Ani and whether or not there is contamination due to the ink mist on the inner wall of the collection nozzle 4 (in other words, the wall surfaces of the side cover 411 and the barrier rib 441). In this table, "○" indicates that there is no contamination and "×" indicates that there is contamination. In this figure, the result in a case where the width of the air intake opening Ani is 2.5 mm is obtained by an experiment, not by the above-described simulation.

FIG. 17A is a view schematically showing an experiment for checking an effect of the tilt of a suction nozzle. In the experiment shown in FIG. 17A, a teardrop-shaped suction nozzle is created and respective members which correspond to the side cover 411 and the barrier rib 441 are attached to an opening at a tip of the suction nozzle. Further, to the inner sides of both the members, glossy photo paper is attached. Then, in a case where the ink mist is sucked by the suction nozzle while changing the tilt θ of the suction nozzle with respect to a virtual straight line perpendicular to the printing medium M, the ink mist adhering to the glossy photo paper is checked. Furthermore, the tilt θ of the suction nozzle with respect to the virtual straight line is represented, for example, by an angle formed between the virtual straight line and the side cover 411 (or the barrier rib 441).

FIG. 17B is a view showing a result of the experiment shown in FIG. 17A in a table form. This table shows the angle formed between the suction nozzle and the printing medium M and whether or not there is contamination due to the ink mist on the inner wall of the collection nozzle 4 (in other words, the wall surfaces of the side cover 411 and the barrier rib 441). In this table, "○" indicates that there is no contamination and "×" indicates that there is contamination. Further, "△" indicates that contamination is recognized but allowed. In this exemplary case, when the angle is in a range from 95 degrees to 60 degrees, the contamination due to the ink mist is allowed. Then, for example, the angle of the suction nozzle with respect to the printing medium M may be set to be not smaller than 85 degrees and not larger than 95 degrees. In other words, the tilt θ (absolute value) of the suction nozzle with respect to the virtual straight line perpendicular to the printing medium M should be not larger than 5 degrees. In such a configuration, it is possible to effectively suppress adhesion of the ink mist onto the inner wall of the collection nozzle.

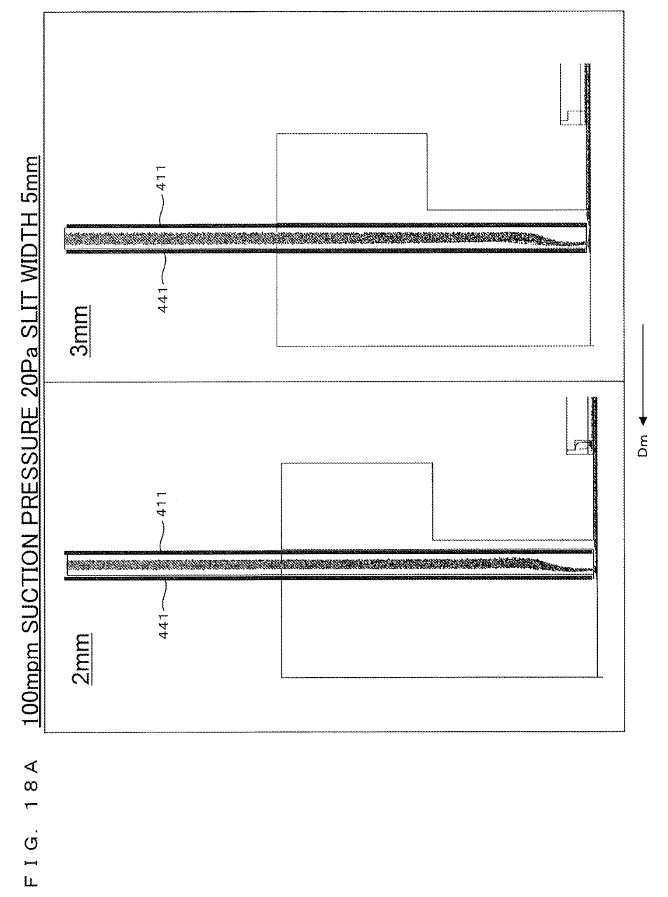

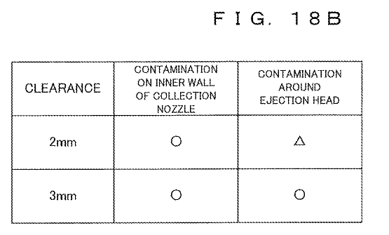

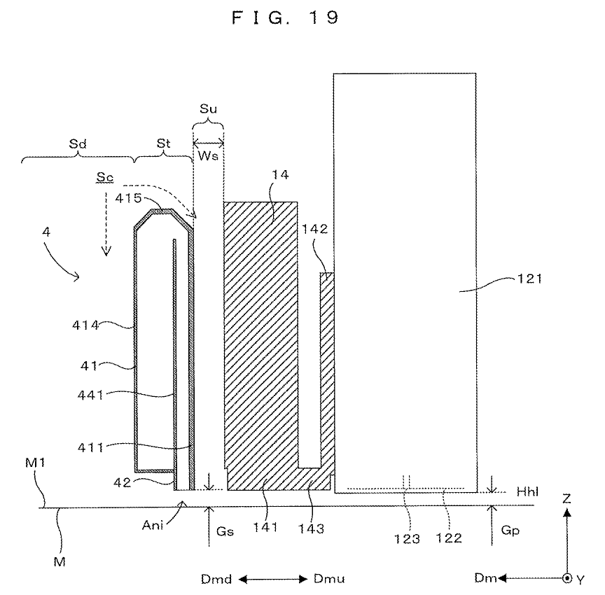

FIG. 18A is a view showing a simulation result of a diffusion manner of the ink mist sucked into the collection nozzle. In this figure, dots represent the ink mist. This figure shows respective results obtained when the width of the space Su in the transfer direction Dm is 2 mm and 3 mm in a case where the transfer speed of the printing medium M in the transfer direction Dm is 100 mpm (meter per minute), the pressure for sucking the air intake opening Ani is 20 Pa, and the width Wa (slit width) of the air intake opening Ani is 5 mm.

FIG. 18B is a view showing whether the width of the air intake opening is suitable or not in a table form. This table shows the width (clearance) of the space Su, whether or not there is contamination due to the ink mist on the inner wall of the collection nozzle 4 (in other words, the wall surfaces of the side cover 411 and the barrier rib 441) and whether or not there is contamination due to the ink mist around the ejection head 121. In this table, "○" indicates that there is no contamination and "×" indicates that there is contamination. From these results, it can be seen that when the width of the space Su in the transfer direction Dm is made to be larger than 2 mm, it is possible to prevent the contamination due to the ink mist on both the collection nozzle 4 and the ejection head 121.

In the above-described embodiment, the printing medium M corresponds to one example of a "printing medium" of the present disclosure, the transfer direction Dm corresponds to one example of a "transfer direction" of the present disclosure, the transfer part 2 corresponds to one example of a "printing medium transfer part" of the present disclosure, the ejection head 121 corresponds to one example of an "ejection head" of the present disclosure, the air intake opening Ani corresponds to one example of an "air intake opening" of the present disclosure, the collection nozzle 4 or the collection nozzle 8 corresponds to one example of a "collection nozzle" of the present disclosure, the space Su corresponds to one example of a "first space" of the present disclosure, the space Sd corresponds to one example of a "second space" of the present disclosure, the clean airflow Fcu corresponds to one example of a "first airflow" of the present disclosure, the clean airflow Fcd corresponds to one example of a "second airflow" of the present disclosure, the printer 1 corresponds to one example of a "printer" of the present disclosure, the nozzle opening surface 122 corresponds to one example of a "nozzle opening surface" of the present disclosure, the ejection nozzle 123 corresponds to one example of an "ejection nozzle" of the present disclosure, the side cover 411 corresponds to one example of a "first standing plate" of the present disclosure, the barrier rib 441 corresponds to one example of a "second standing plate" of the present disclosure, the base frame 14 corresponds to one example of a "head support member" of the present disclosure, the attachment mechanism 15 or the attachment mechanism 16 corresponds to one example of a "nozzle support member" of the present disclosure, and the base plate 141 corresponds to one example of a "side wall plate" of the present disclosure.

Further, the present disclosure is not limited to the above-described embodiment, but numerous modifications and variations other than those described above can be devised without departing from the scope of the disclosure. For example, as shown in FIG. 19, the collection nozzle 4 can be disposed with respect to the ejection head 121. FIG. 19 is a partial sectional view schematically showing a variation of a positional relation of the collection nozzle with respect to the ejection head. In the exemplary case shown in FIG. 19, the space Su left between the base frame 14 and the collection nozzle 4 has a width Ws in the transfer direction Dm. Herein, the width Ws is represented by the narrowest interval among the interval between the base frame 14 and the collection nozzle 4. Further, a print gap Gp which corresponds to the distance between the nozzle opening surface 122 of the ejection head 121 positioned at the print height Hhl and the front surface M1 of the printing medium M is narrower than the width Ws of the space Su. In other words, the print gap Gp between the nozzle opening surface 122 and the front surface M1 of the printing medium M at the time when the ejection head 121 ejects ink onto the front surface M1 of the printing medium M is narrower than the width Ws of the space Su. For example, the width Ws of the space Su is 1 to 4 mm, and the print gap Gp is 0.8 to 1.5 mm. Further, a suction gap Gs which corresponds to the distance between the lower end of the collection nozzle 4 and the front surface M1 of the printing medium M is, for example, equal to the print gap Gp or wider than the print gap Gp.

In the exemplary case shown in FIG. 19, the ejection head 121 has the nozzle opening surface 122 facing the printing medium M and the ejection nozzle 123 which is opened in the nozzle opening surface 122, and ejects ink onto the printing medium M from the ejection nozzle 123. The width Ws of the space Su (first space) in the transfer direction Dm is wider than the print gap Gp between the printing medium M transferred by the transfer part 2 (printing medium transfer part) and the nozzle opening surface 122. In such a configuration, it is possible to bring the ejection head 121 close to the printing medium M while ensuring the wide space Su. For this reason, as compared with the airflow going from between the nozzle opening surface 122 and the printing medium M toward the air intake opening Ani, the clean airflow Fcu (first airflow) going from the space Su toward the air intake opening Ani is more easily generated. In other words, it is possible to suppress generation of the airflow going from between the ejection head 121 and the printing medium M toward the air intake opening Ani of the collection nozzle 4. As a result, it is possible to stably eject ink onto the printing medium from the ejection head 121.

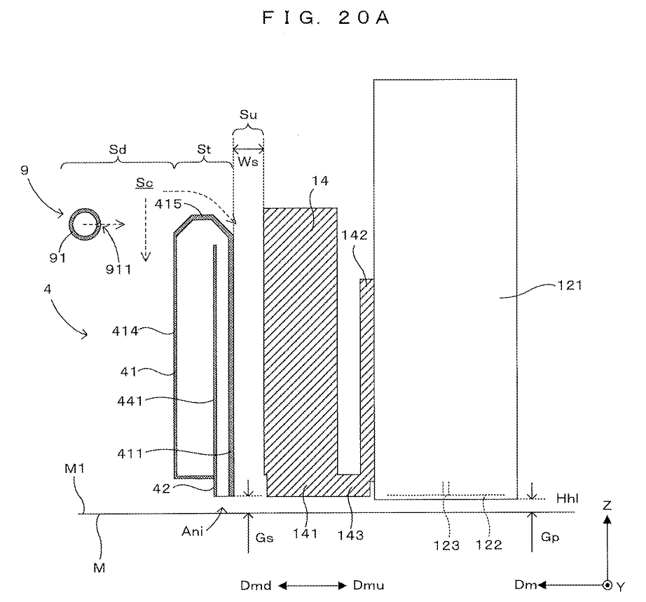

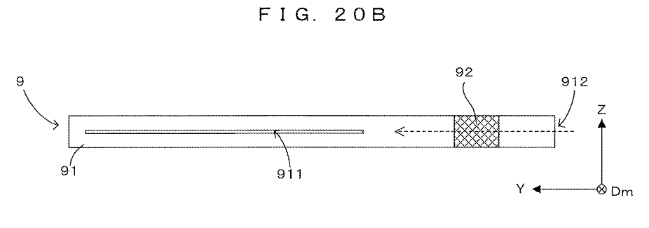

FIG. 20A is a partial sectional view schematically showing a variation of the printer, and FIG. 20B is a view schematically showing a cleaned air supply unit included in the printer shown in FIG. 20A. The printer 1 shown in FIG. 20A has a cleaned air supply unit 9. The cleaned air supply unit 9 has a cleaned air supply pipe 91 disposed on the downstream side Dmd of the collection nozzle 4 in the transfer direction Dm. The cleaned air supply pipe 91 is disposed in parallel with the Y direction in the space Sc. Further, the cleaned air supply pipe 91 has an air outflow port 911 which is a slit extended in parallel with the Y direction. Then, as indicated by a broken-line arrow in FIG. 20A, air flows out from the inside of the cleaned air supply pipe 91 to the outside thereof (space Sc) through the air outflow port 911. Furthermore, the configuration of the air outflow port 911 is not limited to a slit but may be a plurality of holes arranged in the Y direction. Further, at an end of the cleaned air supply pipe 91 in the Y direction, provided is an air inflow port 912 which is opened to the outside of the cabinet 11 of the printer 1.

Furthermore, the cleaned air supply unit 9 has a filter 92 disposed inside the cleaned air supply pipe 91. The filter 92 is disposed between the air outflow port 911 and the air inflow port 912 in the Y direction. Therefore, the air flowing in from the air inflow port 912 goes through the filter 92 and then flows out from the air outflow port 911. Therefore, clean air whose extraneous matters are removed by the filter flows out from the air outflow port 911. Thus, the air flowing out from the air outflow port 911 becomes the clean airflow Fcd or the clean airflow Fcu and is sucked into the collection nozzle 4 from the air intake opening Ani.

Further, the width Wa (size) of the air intake opening Ani is not limited to the above-described specific example.

Furthermore, the thickness Tu of the side cover 411 or the thickness Td of the barrier rib 441 is not limited to the above-described specific example.

Further, the flange 431 of the nozzle exhaust part 43 and the flange 511 of the exhaust duct 5 may be connected to each other. In this case, it is favorable that the exhaust duct 5 can be deformed flexibly.

Furthermore, a time period while the suction fan 72 operates is not limited to that for the image printing. Therefore, the suction fan 72 may be operated through the image printing and the non-image printing.

Further, the number of or the arrangement of the suction fans 72 can be changed as appropriate.

Furthermore, the cushioning material 32 may be bonded to the flange 511, not to the flange 431.

Further, various materials can be used as respective materials of the flange 431 and the flange 511. Specifically, the material for these flanges may be a resin or a metal.

The present disclosure is applicable to a general technique for collecting an ink mist generated when ink is ejected onto a printing medium to print an image.

As described above, the printer may be configured so that a size of the air intake opening in the transfer direction is larger than 2 mm and smaller than 7 mm. It is thereby possible to effectively suppress adhesion of the ink mist onto the inner wall of the collection nozzle.

The printer may be configured so that the ejection head has a nozzle opening surface facing the printing medium and an ejection nozzle which is opened in the nozzle opening surface, to eject ink from the ejection nozzle onto the printing medium, and the first space is provided from the printing medium transferred by the printing medium transfer part up to the one side relative to the nozzle opening surface. In such a configuration, it is possible to generate a layer of relatively clean airflow along the inner wall of the collection nozzle and effectively suppress adhesion of the ink mist onto the inner wall of the collection nozzle.

The printer may be configured so that the second space is provided from the printing medium transferred by the printing medium transfer part up to the one side relative to the nozzle opening surface. In such a configuration, it is possible to generate a layer of relatively clean airflow along the inner wall of the collection nozzle and effectively suppress adhesion of the ink mist onto the inner wall of the collection nozzle.

The printer may be configured so that the collection nozzle has a first standing plate standing from the air intake opening to the one side on an upstream side of the air intake opening in the transfer direction and a second standing plate standing from the air intake opening to the one side on a downstream side of the air intake opening in the transfer direction, and a thickness of the first standing plate is smaller than 2 mm and a thickness of the second standing plate is smaller than 2 mm in the transfer direction. In such a configuration, it is possible to suppress the effect of the respective thicknesses of the first standing plate and the second standing plate and reliably generate a layer of relatively clean airflow along the inner wall of the collection nozzle. As a result, it is possible to effectively suppress adhesion of the ink mist onto the inner wall of the collection nozzle.

The printer may be configured so that the collection nozzle has a first standing plate standing from the air intake opening to the one side on an upstream side of the air intake opening in the transfer direction and a second standing plate standing from the air intake opening to the one side on a downstream side of the air intake opening in the transfer direction, and a thickness of the first standing plate is smaller than a size of the air intake opening and a thickness of the second standing plate is smaller than a size of the air intake opening in the transfer direction. In such a configuration, it is possible to suppress the effect of the respective thicknesses of the first standing plate and the second standing plate and reliably generate a layer of relatively clean airflow along the inner wall of the collection nozzle. As a result, it is possible to effectively suppress adhesion of the ink mist onto the inner wall of the collection nozzle.

The printer may be configured so that the first space is provided from the printing medium transferred by the printing medium transfer part up to the one side relative to an end of the collection nozzle on the one side. In such a configuration, it is possible to generate a layer of relatively clean airflow along the inner wall of the collection nozzle and effectively suppress adhesion of the ink mist onto the inner wall of the collection nozzle.

The printer may be configured so that the second space is provided from the printing medium transferred by the printing medium transfer part up to the one side relative to the end of the collection nozzle on the one side. In such a configuration, it is possible to generate a layer of relatively clean airflow along the inner wall of the collection nozzle and effectively suppress adhesion of the ink mist onto the inner wall of the collection nozzle.

The printer may be configured so that the first space and the second space are connected to each other with a space therebetween, which is provided on the one side relative to the end of the collection nozzle on the one side. In such a configuration, it is possible to generate a layer of relatively clean airflow along the inner wall of the collection nozzle and effectively suppress adhesion of the ink mist onto the inner wall of the collection nozzle.

The printer may further comprises: a head support member supporting the ejection head; and a nozzle support member supporting the collection nozzle with respect to the head support member, wherein the head support member has a side wall plate positioned between the ejection head and the collection nozzle in the transfer direction, and the nozzle support member supports the collection nozzle with the first space left between the side wall plate and the collection nozzle. In such a configuration, adhesion of the ink mist onto the inner wall of the collection nozzle is suppressed. For this reason, it becomes possible to suppress adhesion of ink onto the collection nozzle which sucks the ink mist to collect the ink mist.

The printer may be configured so that a tilt between a virtual straight line perpendicular to the printing medium facing the collection nozzle and the collection nozzle is within 5 degrees. In such a configuration, it is possible to effectively suppress adhesion of the ink mist onto the inner wall of the collection nozzle.

The printer may be configured so that the ejection head has a nozzle opening surface facing the printing medium and an ejection nozzle which is opened in the nozzle opening surface, to eject ink from the ejection nozzle onto the printing medium, and the width of the first space in the transfer direction is larger than the distance between the printing medium transferred by the printing medium transfer part and the nozzle opening surface. In such a configuration, it is possible to bring the ejection nozzle close to the printing medium while ensuring the wide first space. For this reason, as compared with the airflow going from between the nozzle opening surface and the printing medium toward the air intake opening, the first airflow going from the first space toward the air intake opening is more easily generated. In other words, it is possible to suppress generation of the airflow going from between the ejection nozzle and the printing medium toward the air intake opening of the collection nozzle. As a result, it is possible to stably eject ink onto the printing medium from the ejection head.

What is claimed is:

1. A printer, comprising:
a printing medium transfer part transferring a printing medium in a transfer direction;
an ejection head facing the printing medium and ejecting ink onto the printing medium; and
a collection nozzle disposed on a downstream side in the transfer direction relative to the ejection head, having an air intake opening, which faces the printing medium from one side in a direction orthogonal to the printing medium, and sucking from the air intake opening, an ink mist generated by ejection of ink from the ejection head,
wherein a first space is provided between the collection nozzle and the ejection head in the transfer direction and a second space is provided on a downstream side of the collection nozzle in the transfer direction,
a first airflow going from the one side toward the other side opposite to the one side in the first space is generated by giving pressure for generating the first airflow to the first space from only the other side among the one side and the other side,
a second airflow going from the one side toward the other side in the second space is generated by giving pressure for generating the second airflow to the second space from only the other side among the one side and the other side,
the pressure for generating the first airflow and the pressure for generating the second airflow are generated by the collection nozzle sucking from the air intake opening,
the first airflow having flowed out from the first space toward the other side flows into the collection nozzle from the air intake opening, and
the second airflow having flowed out from the second space toward the other side flows into the collection nozzle from the air intake opening.

2. The printer according to claim 1, wherein
a size of the air intake opening in the transfer direction is larger than 2 mm and smaller than 7 mm.

3. The printer according to claim 1, wherein
the ejection head has a nozzle opening surface facing the printing medium and an ejection nozzle which is opened in the nozzle opening surface, to eject ink from the ejection nozzle onto the printing medium, and
the first space is provided from the printing medium transferred by the printing medium transfer part up to the one side relative to the nozzle opening surface.

4. The printer according to claim 3, wherein
the second space is provided from the printing medium transferred by the printing medium transfer part up to the one side relative to the nozzle opening surface.

5. The printer according to claim 1, wherein
the collection nozzle has a first standing plate standing from the air intake opening to the one side on an upstream side of the air intake opening in the transfer direction and a second standing plate standing from the air intake opening to the one side on a downstream side of the air intake opening in the transfer direction, and
a thickness of the first standing plate is smaller than 2 mm and a thickness of the second standing plate is smaller than 2 mm in the transfer direction.

6. The printer according to claim 1, wherein
the collection nozzle has a first standing plate standing from the air intake opening to the one side on an upstream side of the air intake opening in the transfer direction and a second standing plate standing from the air intake opening to the one side on a downstream side of the air intake opening in the transfer direction, and
a thickness of the first standing plate is smaller than a size of the air intake opening and a thickness of the second standing plate is smaller than a size of the air intake opening in the transfer direction.

7. The printer according to claim 1, wherein
the first space is provided from the printing medium transferred by the printing medium transfer part up to the one side relative to an end of the collection nozzle on the one side.

8. The printer according to claim 7, wherein
the second space is provided from the printing medium transferred by the printing medium transfer part up to the one side relative to the end of the collection nozzle on the one side.

9. The printer according to claim 8, wherein
the first space and the second space are connected to each other with a space therebetween, which is provided on the one side relative to the end of the collection nozzle on the one side.

10. The printer according to claim 1, further comprising:
a head support member supporting the ejection head; and
a nozzle support member supporting the collection nozzle with respect to the head support member,
wherein the head support member has a side wall plate positioned between the ejection head and the collection nozzle in the transfer direction, and
the nozzle support member supports the collection nozzle with the first space left between the side wall plate and the collection nozzle.

11. The printer according to claim 1, wherein
a tilt between a virtual straight line perpendicular to the printing medium facing the collection nozzle and the collection nozzle is within 5 degrees.

12. The printer according to claim 1, wherein
the ejection head has a nozzle opening surface facing the printing medium and an ejection nozzle which is opened in the nozzle opening surface, to eject ink from the ejection nozzle onto the printing medium, and
the width of the first space in the transfer direction is larger than the distance between the printing medium transferred by the printing medium transfer part and the nozzle opening surface.

13. An ink mist collection method, comprising:
transferring a printing medium in a transfer direction;
ejecting ink onto the printing medium from an ejection head facing the printing medium; and
sucking an ink mist, which is generated by ejection of ink from the ejection head, from an air intake opening by a collection nozzle which is disposed on a downstream side in the transfer direction relative to the ejection head, has the air intake opening facing the printing medium from one side in a direction orthogonal to the printing medium,
wherein a first space is provided between the collection nozzle and the ejection head in the transfer direction and a second space is provided on a downstream side of the collection nozzle in the transfer direction,
a first airflow going from the one side toward the other side opposite to the one side in the first space is generated by giving pressure for generating the first airflow to the first space from only the other side among the one side and the other side,
a second airflow going from the one side toward the other side in the second space is generated by giving pressure for generating the second airflow to the second space from only the other side among the one side and the other side,
the pressure for generating the first airflow and the pressure for generating the second airflow are generated by the collection nozzle sucking from the air intake opening,
the first airflow having flowed out from the first space toward the other side flows into the collection nozzle from the air intake opening, and
the second airflow having flowed out from the second space toward the other side flows into the collection nozzle from the air intake opening.
